(19) United States
(12) Patent Application Publication
(10) Pub. No.: US 2026/0342132 A1
(43) Pub. Date: Oct. 29, 2026

(54) WEARALBE ELECTRONIC DEVICE AND CHARGING SYSTEM INCLUDING SAME

(71) Applicant: Samsung Electronics Co., Ltd., Suwon-si (KR)

(72) Inventors: Taehyun WOO, Suwon-si (KR); Sangjoon MO, Suwon-si (KR); Chulhan KIM, Suwon-si (KR); Jedok KIM, Suwon-si (KR); Beomwoo GU, Suwon-si (KR)

(21) Appl. No.: 19/656,844

(22) Filed: Apr. 23, 2026

Related U.S. Application Data
(63) Continuation of application No. PCT/KR2026/096038, filed on Apr. 17, 2026.

(30) Foreign Application Priority Data
Apr. 28, 2025 (KR) 10-2025-0055668
Jun. 16, 2025 (KR) 10-2025-0078924
Dec. 15, 2025 (KR) 10-2025-0199607

(51) Int. Cl. H02J 50/00; G06F 1/16; H01M 50/107; H02J 50/12; H02J 50/70; H02J 50/80; H02J 50/90

(52) U.S. Cl. CPC H02J 50/005; G06F 1/163; H01M 50/107; H02J 50/12; H02J 50/70; H02J 50/80; H01M 2220/30; H02J 50/90

(57) ABSTRACT

A ring-type wearable electronic device may include a ring-shaped housing and including an outer housing and an inner housing, a curved battery disposed inside the housing, a first wireless charging coil configured to wirelessly charge the curved battery via at least a portion of the inner housing and disposed at a first portion adjacent to a first end portion of the curved battery, a communication antenna configured to communicate with an external electronic device via the inner housing and disposed at a second portion adjacent to a second end portion of the curved battery, located at a side opposite to the first end portion, and at least one sensor configured to obtain data from a user and disposed at a third portion located between the first portion and the second portion.

### CROSS-REFERENCE TO RELATED APPLICATIONS

This application is a continuation of International Application No. PCT/KR2026/096038 designating the United States, filed on Apr. 17, 2026, in the Korean Ministry of Intellectual Property Receiving Office and claiming priority to Korean Patent Application Nos. 10-2025-0055668, filed on Apr. 28, 2025, 10-2025-0078924, filed on Jun. 16, 2025, and 10-2025-0199607, filed on Dec. 15, 2025, in the Korean Ministry of Intellectual Property, the disclosures of each of which are incorporated by reference herein in their entireties.

### BACKGROUND

### Field

The disclosure relates to a wearable electronic device and a charging system including the same. For example, the disclosure relates to a ring-type wearable electronic device and a charging system including the ring-type wearable electronic device and a charging device for charging the ring-type wearable electronic device.

### Description of Related Art

Recently, electronic devices have been developed in various forms for user convenience and have been reduced in size so that users may carry them more easily. For example, an electronic device may be provided in a ring type that is wearable on a user’s finger. As interest in health increases, interest in technologies capable of checking health conditions has also increased accordingly.

Accordingly, an electronic device may include sensors for measuring a user’s biometric information and has been developed in various forms to measure and utilize various biometric signals of the human body using sensors. Through the measurement of various biometric signals, the electronic device may provide various services for managing or checking the user’s health conditions.

The above-described information may be provided as related art for the purpose of helping to understand the disclosure. No assertion or determination is made regarding whether any of the foregoing may be applied as prior art with respect to the disclosure.

### SUMMARY

According to an example embodiment, a ring-type wearable electronic device may include a curved battery disposed inside its housing.

According to an example embodiment, the ring-type wearable electronic device may include a first wireless charging coil configured to wirelessly charge the curved battery via at least a portion of the inner housing part, and disposed at a first portion adjacent to a first end portion of the curved battery.

According to an example embodiment, the ring-type wearable electronic device may include a communication antenna configured to communicate with an external electronic device via the inner housing part, and disposed at a second portion adjacent to a second end portion of the curved battery, located at a side opposite to the first end portion.

According to an example embodiment, the ring-type wearable electronic device may include at least one sensor configured to obtain data from a user, and disposed at a third portion located between the first portion and the second portion.

According to an example embodiment, a charging system may be configured to charge a ring-type wearable electronic device.

According to an example embodiment, the charging system may include a wearable electronic device.

According to an example embodiment, the charging system may include a charging device including a housing configured such that the wearable electronic device is seated thereon.

According to an example embodiment, the wearable electronic device of the charging system may include a first housing including an outer housing part and an inner housing part at least partially transparent.

According to an example embodiment, the wearable electronic device of the charging system may include a curved battery disposed inside the first housing.

According to an example embodiment, the wearable electronic device of the charging system may include a first wireless charging coil configured to receive power wirelessly from the charging device via at least a portion of the inner housing part. The first wireless charging coil may be disposed inside the first housing at a first portion adjacent to a first end portion of the curved battery and may be electrically connected to the curved battery.

According to an example embodiment, the wearable electronic device of the charging system may include a communication antenna configured to communicate with an external electronic device via at least a portion of the inner housing part. The communication antenna may be disposed at a second portion adjacent to a second end portion of the curved battery, at a side opposite to the first end portion.

According to an example embodiment, the wearable electronic device of the charging system may include at least one sensor configured to obtain data from a user, and disposed at a third portion located between the first portion and the second portion.

According to an example embodiment, the charging device of the charging system may include a second housing including a cylindrical seating portion.

According to an example embodiment, the charging device of the charging system may include a third wireless charging coil disposed inside the second housing. The third wireless charging coil may be disposed at a fifth portion corresponding to the first wireless charging coil when the wearable electronic device is seated at the seating portion such that one surface of the wearable electronic device is oriented in a first direction.

According to an example embodiment, the charging device of the charging system may include a fourth wireless charging coil disposed inside the second housing. The fourth wireless charging coil may be disposed at a sixth portion corresponding to the first wireless charging coil when the wearable electronic device is seated at the seating portion such that one surface of the wearable electronic device is oriented in a second direction opposite to the first direction.

### BRIEF DESCRIPTION OF THE DRAWINGS

The above and other aspects, features, and/or advantages of certain embodiments of the present disclosure may be more apparent from the following detailed description, taken in conjunction with the accompanying drawings, in which:

FIG. 1 is a block diagram of an example electronic device in a network environment according to various embodiments.

FIG. 2 is a perspective view of a charging system according to various embodiments.

FIG. 3 is a block diagram illustrating an example configuration of a system for wireless charging of a ring-type wearable electronic device according to various embodiments.

FIG. 4 is a diagram illustrating examples of use of a wearable electronic device according to various embodiments.

FIG. 5 is a perspective view of a wearable electronic device according to various embodiments.

FIG. 6 is a diagram illustrating a front view of the wearable electronic device according to various embodiments.

FIG. 7 is a cross-sectional view of a wearable electronic device according to various embodiments.

FIG. 8 is a partial perspective view illustrating a portion of the configuration of a wearable electronic device according to various embodiments.

FIG. 9 is a diagram illustrating a side view of a portion of a configuration of a wearable electronic device according to various embodiments.

FIG. 10 is a diagram illustrating a side view of a portion of a configuration of a wearable electronic device according to various embodiments.

FIG. 11 is a diagram illustrating an enlarged view of a portion of a configuration of a wearable electronic device according to various embodiments.

FIG. 12 is a diagram illustrating an enlarged view of a portion of a configuration of a wearable electronic device according to various embodiments.

FIG. 13 is a diagram illustrating an enlarged view of a portion of a configuration of a wearable electronic device according to various embodiments.

FIG. 14 is a diagram illustrating a plan view of a portion of a configuration of a wearable electronic device according to various embodiments.

FIG. 15 is a diagram illustrating a plan view of a portion of the configuration of the wearable electronic device according to various embodiments.

FIG. 16 is a cross-sectional view illustrating a portion of the configuration of a wearable electronic device according to various embodiments.

FIG. 17 is a diagram illustrating plan view of a portion of the configuration of a wearable electronic device according to various embodiments.

FIG. 18 is a cross-sectional view illustrating a portion of the configuration of a wearable electronic device according to various embodiments.

FIG. 19 is a cross-sectional view of a wearable electronic device according to various embodiments.

FIG. 20 is a perspective view of a charging system according to various embodiments.

FIG. 21 is a diagram illustrating a plan view of the charging system according to various embodiments.

FIG. 22 is a perspective view of the charging system according to various embodiments.

FIG. 23 is a diagram illustrating a plan view of the charging system according to various embodiments.

FIG. 24 is a diagram illustrating an enlarged view of a portion of a configuration of a charging device according to various embodiments.

FIG. 25 is a diagram illustrating an enlarged view of a portion of a configuration of a charging device according to various embodiments.

FIG. 26 is a diagram illustrating an enlarged view of a portion of a configuration of a charging device according to various embodiments.

FIG. 27 is a circuit diagram illustrating a portion of a configuration of a charging device according to various embodiments.

FIG. 28 is a cross-sectional view of a wearable electronic device according to various embodiments.

FIG. 29 is a cross-sectional view of a wearable electronic device according to various embodiments.

FIG. 30 is a diagram illustrating a plan view of the charging system according to various embodiments.

FIG. 31 is a diagram illustrating a plan view of the charging system according to various embodiments.

FIG. 32 is a circuit diagram illustrating a portion of a configuration of a charging device according to various embodiments.

Throughout the appended drawings, like reference numerals may be assigned to like components, configurations, and/or structures.

### DETAILED DESCRIPTION

The following description with reference to the appended drawings may provide an understanding of various example implementations of the disclosure. Various example embodiments disclosed in the following description include various specific details to help understanding. Therefore, those skilled in the art will appreciate that various changes and modifications of the various implementations described herein may be made without departing from the scope and spirit of the disclosure. In addition, descriptions of well-known functions and configurations may be omitted for clarity and conciseness.

The terms and words used in the following description and claims are not limited to their bibliographical meanings, but may be used to describe an embodiment clearly and consistently. Accordingly, it will be apparent to those skilled in the art that the following description of various implementations of the disclosure is provided for explanatory purposes and not intended to limit the scope of the disclosure and equivalents thereof.

Unless the context clearly indicates otherwise, the singular forms of “a,” “an,” and “the” should be understood to include the plural meaning. Accordingly, for example, the term “a component surface” may be understood to include one or more surfaces of the component.

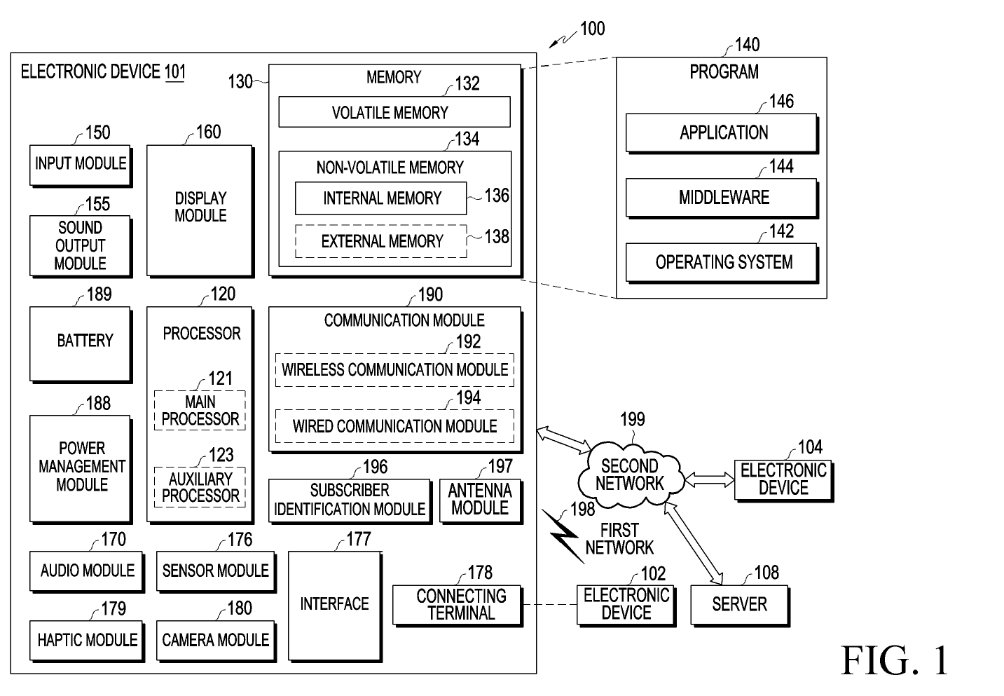

FIG. 1 is a block diagram illustrating an example electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited /disclosed functions, e.g., in a distributed manner. At least one processor may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth^{TM}, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20Gbps or more) for implementing eMBB, loss coverage (e.g., 164dB or less) for implementing mMTC, or U-plane latency (e.g., 0.5ms or less for each of downlink (DL) and uplink (UL), or a round trip of 1ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as "A or B," "at least one of A and B," "at least one of A or B," "A, B, or C," "at least one of A, B, and C," and "at least one of A, B, or C," may include any one of, or all possible combinations of the items enumerated together in a corresponding one of the phrases. As used herein, such terms as "1st" and "2nd," or "first" and "second" may be used to simply distinguish a corresponding component from another, and does not limit the components in other aspect (e.g., importance or order). It is to be understood that if an element (e.g., a first element) is referred to, with or without the term "operatively" or "communicatively", as "coupled with," "coupled to," "connected with," or "connected to" another element (e.g., a second element), the element may be coupled with the other element directly (e.g., wiredly), wirelessly, or via a third element.

As used in connection with various embodiments of the disclosure, the term "module" may include a unit implemented in hardware, software, or firmware, or any combination thereof, and may interchangeably be used with other terms, for example, "logic," "logic block," "part," or "circuitry". A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the "non-transitory" storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore^{TM}), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

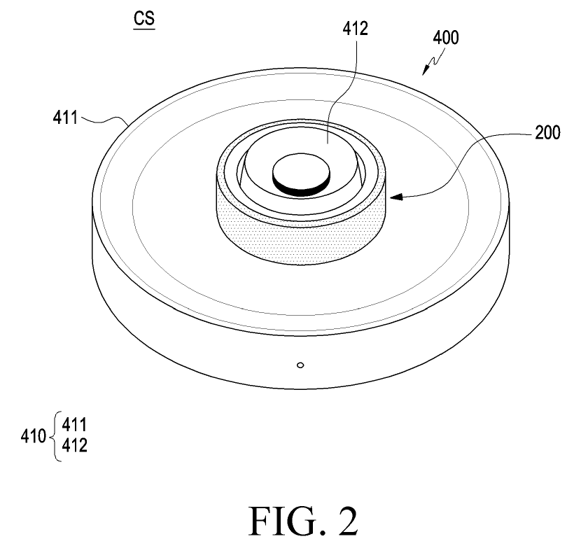

FIG. 2 is a perspective view of a charging system according to various embodiments.

Detailed configurations of the wearable electronic device 200 that is not described below may be the same as or similar to the detailed configurations of the electronic device 101 described with reference to FIG. 1.

According to an embodiment, the charging system CS may be configured to charge a ring-type wearable electronic device 200.

According to an embodiment, the charging system CS may include the wearable electronic device 200 and a charging device 400. The charging device 400 may be configured such that the ring-type wearable electronic device 200 is seated thereon. For example, the wearable electronic device 200 may be detachably seated on the charging device 400. For example, the charging device 400 may include a second housing 410, and the second housing 410 may include a base part 411 and a seating portion 412 protruding upward from a central region of the base part 411. The wearable electronic device 200 may be seated on the charging device 400 by being disposed to surround the seating portion 412. The charging device 400 may be referred to as a “cradle.”

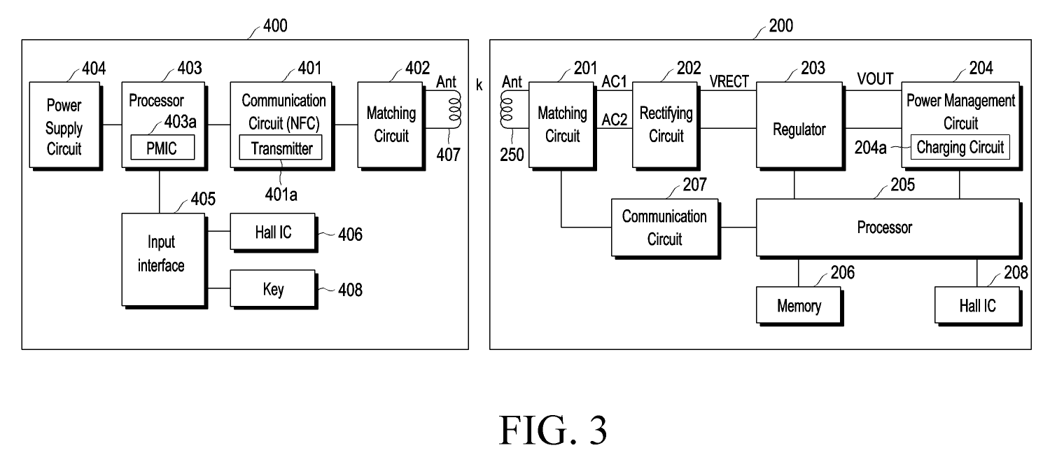

FIG. 3 is a block diagram illustrating an example configuration of a system for wireless charging of a ring-type wearable electronic device according to various embodiments.

According to an embodiment, the wearable electronic device 200 may be connected to a charging device 400 configured to transmit wireless power, through near-field wireless communication (e.g., NFC communication). In an embodiment, a near-field wireless communication scheme may include a magnetic induction scheme or a magnetic resonance scheme, and there is no limitation on the specification of the near-field wireless communication scheme. In a magnetic induction scheme, for example, a size of a coil 250 may be relatively small due to a difference between a resonance frequency of a coil 407 and a frequency of a signal transmitted from the charging device 400 to the wearable electronic device 200. In a magnetic resonance scheme, a resonance frequency of the coil 407 of the charging device 400 may correspond to a resonance frequency of the coil 250 of the wearable electronic device 200.

According to an embodiment, the charging device 400 may include circuits (e.g., devices, modules, or components) for wirelessly transmitting power for wireless charging to the wearable electronic device 200 as a receiving device. According to an embodiment, the charging device 400 may include a TX antenna coil 407, a communication circuit 401 including a power supply circuit 404 and a transmitter (NFC) 401a, a matching circuit 402, a processor (e.g., including processing circuitry) 403 including a PMIC 403a, an input interface (e.g., including circuitry) 405, and a Hall IC 406. Other components required for wireless charging may further be included.

According to an embodiment, the processor 403 may include various processing circuitry and perform operations of configuring, charging, and/or checking a state of the charging device 400 and/or the wearable electronic device 200 through the input interface 405. The description of the processor 120 above applies equally to the processor 403 here, and as such a detailed description is not repeated here. For example, the processor 403 may perform, through the input interface 405, a configuring operation of the wearable electronic device 200 (e.g., a booting and/or initialization operation of the wearable electronic device 200), a pairing operation, a wireless charging operation, an operation of checking a state of charge (SOC) of the charging device 400 and the wearable electronic device 200, and/or an operation of identifying opening and closing of the charging device 400. For example, the Hall IC 406 may be connected to the input interface 405 and/or the processor 403, and may include a Hall sensor. The charging device 400 may identify an opening and closing state of an opening/closing member (not illustrated) connected to one side of the second housing (e.g., the second housing 410 of FIG. 2) based on sensor information (e.g., Hall information) acquired by the Hall sensor. For example, a key 408 may be connected to the input interface 405 and/or the processor 403. A user may operate the key 408, and key 408 input information from the user may be transmitted to the processor 403 via the input interface 405. Based on the key 408 input information, a configuring operation of the wearable electronic device 200 (e.g., a booting and/or initialization operation of the wearable electronic device 200), a pairing operation of the wearable electronic device 200, a wireless charging operation, and/or an operation of displaying respective states of charge of the wearable electronic device 200 and the charging device 400 may be performed. Respective states of charge of the wearable electronic device 200 and the charging device 400 may be displayed by a display device (e.g., an LED) exposed to the outside of the charging device 400. The wearable electronic device 200 and the charging device 400 may exchange information on respective states of charge with each other through respective antennas (e.g., the coils 250 and 470).

According to an embodiment, the processor 403 may provide, through a signal line, a control signal for a configuring operation of the wearable electronic device 200 and/or a control signal for a pairing operation of the wearable electronic device 200 to the transmitter 401a. Based on the control signal provided by the processor 403, a signal for the configuring operation (e.g., a booting or initialization operation of the wearable electronic device 200) of the wearable electronic device 200, a signal for the pairing operation of the wearable electronic device 200, and/or a signal for a wireless charging operation may be wirelessly transmitted through the coil 407. The transmitter 401a may include components configured to convert a voltage received from the power supply circuit 404 into a specific AC voltage (e.g., a converter and/or an amplifier). For example, the PMIC 403a may receive power from the power supply circuit 404 and may provide a voltage (e.g., a pogo voltage) to the transmitter 401a through a power line. The matching circuit 402 may match an impedance between the coil 407 and the transmitter 401a to increase power transmission efficiency. The coil 407 may transmit wireless power using a predetermined resonance frequency according to a voltage applied from the matching circuit 402.

According to an embodiment, whether the wearable electronic device 200 is seated on the charging device 400 may be identified through the coil 407. For example, the coil 407 of the charging device 400 may be configured to transmit periodic ping signals. When the wearable electronic device 200 is seated on the charging device 400, a coil 205 of the wearable electronic device 200 may be configured to transmit a response signal to the coil 407 of the charging device 400 in response to the ping signal transmitted from the charging device 400. The processor 403 may determine whether the wearable electronic device 200 is seated, based on the response signal received by the coil 407 of the charging device 400.

According to an embodiment, the wearable electronic device 200 may include a power receiving circuit including an RX antenna coil 250, a matching circuit 201, a rectifying circuit 202, a regulator 203, and a power management circuit 204 (e.g., PMIC) including a charging circuit 204a (e.g., the power management module 188 of FIG. 1), a processor (e.g., including processing circuitry) 205 (e.g., the processor 120 of FIG. 1), memory 206 (e.g., the memory 130 of FIG. 1), a communication circuit 207 (e.g., the communication module 190 of FIG. 1), and a Hall circuit (Hall IC) 208. Other components required for wireless charging may further be included.

According to an embodiment, a coil 250 (e.g., a resonator) included in the power receiving circuit of the wearable electronic device 200 may receive wireless power (e.g., AC power) from the charging device 400 using a predetermined resonance frequency. The wearable electronic device 200 may further include other components required to receive the wireless power.

According to an embodiment, the matching circuit 201 of the wearable electronic device 200 may be configured to perform impedance matching to increase the efficiency of wireless power reception by matching at least one near-field wireless communication antenna (e.g., an NFC antenna or a wireless charging coil). The matching circuit 201 may be configured to apply an AC1 voltage and an AC2 voltage applied to both ends of the coil 250 to the rectifying circuit 202. For example, the matching circuit 201 may be configured to be electrically connected to the coil 250, the processor 205, and the communication circuit 207.

According to an embodiment, the rectifying circuit 202 of the wearable electronic device 200 may be configured to rectify an alternating voltage (AC voltage) applied from the coil 250 into direct current and output the rectified direct voltage (DC voltage) to the regulator 203. The rectifying circuit 202 may be configured to be electrically connected to the matching circuit 201 and the regulator 203.

According to an embodiment, the regulator 203 of the wearable electronic device 200 may be configured to convert a voltage VRECT rectified by the rectifying circuit 202 into a specific direct current (DC) voltage and to process signals transmitted and received through communication between the charging device 400 and the wearable electronic device 200. The regulator 203 may be configured to be electrically connected to the rectifying circuit 202, the power management circuit 204, and the processor 205.

According to an embodiment, the power management circuit 204 (e.g., the power management module 188 of FIG. 1) of the wearable electronic device 200 may include components configured to manage the charging circuit 204a (e.g., the battery 189 of FIG. 1) and wireless charging and may be configured to perform charging by applying a charging voltage (e.g., a specific DC voltage VBUS_SV or an output voltage VOUT) output from the regulator 203 to the charging circuit 204a. The power management circuit 204 may be configured to be electrically connected to the regulator 203 and the processor 205. A Hall circuit 208 may be configured to be connected to the processor 205 and may include a Hall sensor. The wearable electronic device 200 may identify whether it is positioned to (e.g., seated on) the second housing (e.g., the second housing 410 of FIG. 2) of the charging device 400 based on sensor information (e.g., Hall information) acquired by the Hall sensor and/or a charging voltage (e.g., VOUT, 5V). The wearable electronic device 200 may identify separation (e.g., detachment) based on the sensor information (e.g., Hall information) acquired by the Hall sensor.

According to an embodiment, the processor 205 of the wearable electronic device 200 may include various processing circuitry and control overall operations for wireless charging and may control operations of the rectifying circuit 202, the regulator 203, and the power management circuit 204 that are electrically connected thereto. The description of the processor 120 above applies equally to the processor 205 here, and as such a detailed description is not repeated here. The processor 205 may acquire state information and/or control information related to wireless charging and may control the communication circuit 207 to store the state information and/or control information related to wireless charging in the memory 206 or to transmit the same to an external electronic device (e.g., the charging device 400). The processor 205 may be a processor capable of controlling overall operations for wireless charging or a circuit included in the processor.

According to an embodiment, the communication circuit 207 of the wearable electronic device 200 may transmit and/or receive a signal for performing wireless charging using a wireless communication scheme (e.g., an NFC communication scheme). According to an embodiment, the wearable electronic device 200 may further include a separate antenna connected to the communication circuit 207 that supports a wireless communication scheme (e.g., a Bluetooth low energy (BLE) scheme). For example, the communication circuit 207 may transmit state information and/or control information to the charging device 400 or another external electronic device using a wireless communication scheme (e.g., a BLE communication scheme).

According to an embodiment, the charging device 400 may identify proximity of the wearable electronic device 200. For example, the charging device 400 may identify the proximity of the wearable electronic device 200 to the charging device 400 based on identifying that the wearable electronic device 200 is located within coverage for near-field wireless communication with the charging device 400. The near-field wireless communication supported by the charging device 400 may include a communication scheme for wireless power transmission based on an NFC protocol or a Qi protocol, and the specific communication scheme is not limited thereto.

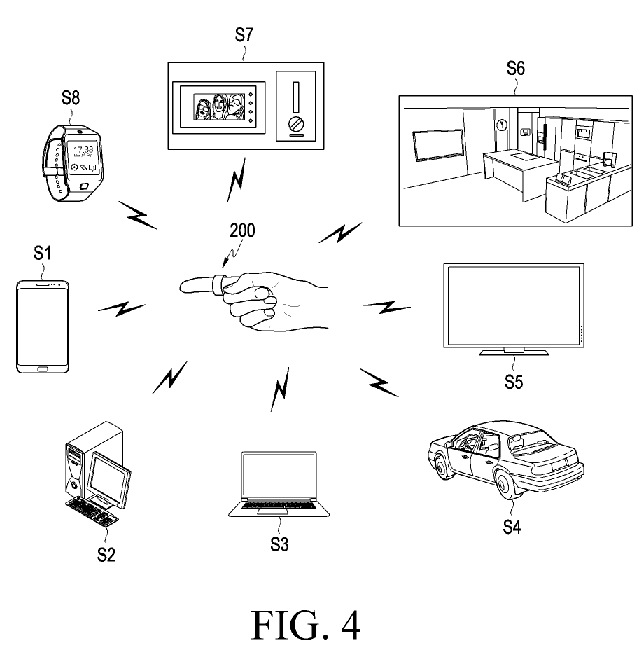

FIG. 4 is a diagram illustrating examples of use of a wearable electronic device according to various embodiments.

Referring to FIG. 4, a wearable electronic device 200 (e.g., the electronic device 101 of FIG. 1) may be configured to be wearable on a user’s body. For example, the wearable electronic device 200 may be implemented as a wearable electronic device that is wearable on a user’s finger. For example, the wearable electronic device 200 may be provided in the form of a ring that is wearable on a user’s wrist. The wearable electronic device 200 may be defined and/or referred to as a smart ring, but is not limited thereto. The wearable electronic device 200 may be referred to as a “ring-type wearable electronic device.”

According to an embodiment, the wearable electronic device 200 may perform wireless communication with another electronic device (e.g., the electronic device 102 or 104 of FIG. 1) through a wireless communication network (e.g., the first network 198 or the second network 199 of FIG. 1). For example, the wearable electronic device 200 may perform wireless communication with other electronic devices such as a smartphone S1, a desktop/laptop computer S2/S3, a vehicle S4, a smart TV S5, indoor smart home devices S6, a tablet PC S7, or a smartwatch S8. The wireless communication between the wearable electronic device 200 and another electronic device may be implemented through a short-range communication network (e.g., the first network 198 of FIG. 1) or a long-range communication network (e.g., the second network 199 of FIG. 1). For example, when a Bluetooth communication link is established between the wearable electronic device 200 and an electronic device to which a user desires to connect, message transmission between the two devices may be enabled. The wearable electronic device 200 worn by the user may generate commands corresponding to specific motions/gestures of the user’s finger and transmit the commands to another electronic device. To detect the user’s finger motions/gestures, the wearable electronic device 200 may include motion sensors such as an accelerometer, a gyroscope, or an electronic compass (e.g., the sensor module 176 of FIG. 1). When a message is received from another electronic device to the wearable electronic device 200, the electronic device 200 may notify the user of message reception using sound, vibration, a display screen, or lighting (e.g., a light-emitting diode or a xenon lamp). For this purpose, the wearable electronic device 200 may include an acoustic module (e.g., the sound output module 155 or the audio module 170 of FIG. 1), a haptic module (e.g., the haptic module 179 of FIG. 1), or a display module (e.g., the display module 160 of FIG. 1). According to an embodiment, in the electronic device, at least one of the acoustic module, the haptic module, or the display module may be omitted, or one or more other components may output information instead. In addition, the wearable electronic device 200 may acquire biometric information (e.g., oxygen saturation) of the user and provide the biometric information to another electronic device.

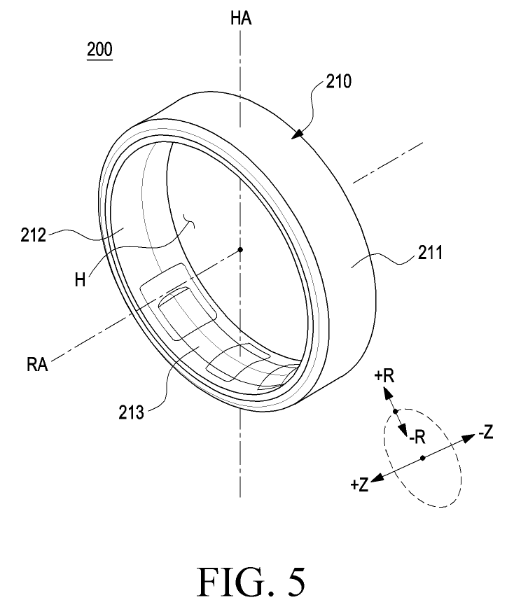

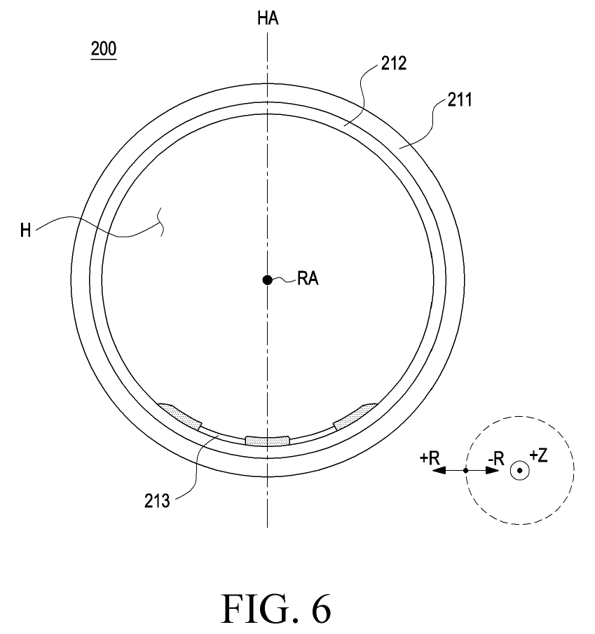

FIG. 5 is a perspective view of a wearable electronic device according to various embodiments. FIG. 6 is a diagram illustrating a front view of the wearable electronic device according to various embodiments.

Detailed configurations of the wearable electronic device 200 that are not described below may be the same as or similar to the detailed configurations of the electronic device 101 described with reference to FIG. 1 and/or the detailed configurations of the wearable electronic device 200 described with reference to FIGS. 2-4.

A ring axis RA may refer to an axis passing through the center of a ring shape of the wearable electronic device 200 and penetrating a hole H of the wearable electronic device 200. A horizontal axis HA may refer to an axis intersecting the ring axis RA, passing through the center of the ring shape of the wearable electronic device 200 (e.g., a point through which the ring axis RA passes) and a central portion of a protrusion 213, and passing through a first housing 210.

The term “first direction” may refer to a +Z direction that is parallel to the ring axis RA and advances forward in the drawing of FIG. 6. The term “second direction” may refer to a -Z direction that is opposite to the first direction (+Z direction) and retreats to the rear side of the drawing of FIG. 6.

The term “outer radial direction” may refer to a +R direction that moves away from the ring axis RA and is directed outward with reference to FIGS. 5 and 6. The term “inner radial direction” may refer to a -R direction that is directed toward the ring axis RA and is opposite to the outer radial direction (+R direction) with reference to FIGS. 5 and 6. The outer radial direction (+R direction) and the inner radial direction (-R direction) may be collectively referred to as a “radial direction.”

According to an embodiment, the wearable electronic device 200 may be a ring-type wearable electronic device 200. The wearable electronic device 200 may have a ring shape (e.g., a ring form) with respect to the ring axis RA. The wearable electronic device 200 may be wearable on a user’s finger. In an embodiment, the wearable electronic device 200 may also be wearable on a user’s wrist or ankle.

According to an embodiment, the wearable electronic device 200 may include a first housing 210. The first housing 210 may form an overall external appearance of the wearable electronic device 200. The first housing 210 may have a ring shape (e.g., a ring type). For example, the first housing 210 may include an opening configured to accommodate a user’s finger. For example, the first housing 210 may include an opening configured to accommodate a user’s wrist or ankle. For example, the opening may be referred to as a hole H. The hole H may be defined by an inner housing part 212 of the wearable electronic device 200. The hole H may be formed through the wearable electronic device 200 in a direction parallel to the ring axis RA. However, the wearable electronic device 200 is not limited to a ring shape, and design modifications may be made such that the wearable electronic device 200 has various forms (e.g., a box shape) that may be worn on and/or fixed to a user’s body (e.g., a finger or a wrist). The first housing 210 of the wearable electronic device 200 may be referred to as a “housing.”

According to an embodiment, the first housing 210 may include an outer housing part 211. The outer housing part 211 may form a surface oriented in a direction away from the ring axis RA of the wearable electronic device 200 (e.g., in the outer radial direction +R). For example, the outer housing part 211 may be configured to form an outer circumferential surface opposite to an inner circumferential surface of the wearable electronic device 200. The outer housing part 211 may be one component of the wearable electronic device 200. For example, the wearable electronic device 200 may include the outer housing part 211.

According to an embodiment, the outer housing part 211 may include a material capable of withstanding an external impact and/or scratches and implementing design characteristics. For example, the outer housing part 211 may include a metal material. For example, the outer housing part 211 may include an aluminum, titanium, and/or stainless steel material. The outer housing part 211 may be color-treated or coated for design implementation.

According to an embodiment, the first housing 210 may include an inner housing part 212. The inner housing part 212 may form a surface oriented in a direction approaching the ring axis RA of the wearable electronic device 200 (e.g., in the inner radial direction -R). For example, the inner housing part 212 may be configured to form an inner circumferential surface facing the ring axis RA of the wearable electronic device 200. The inner housing part 212 may be one component of the wearable electronic device 200. For example, the wearable electronic device 200 may include the inner housing part 212.

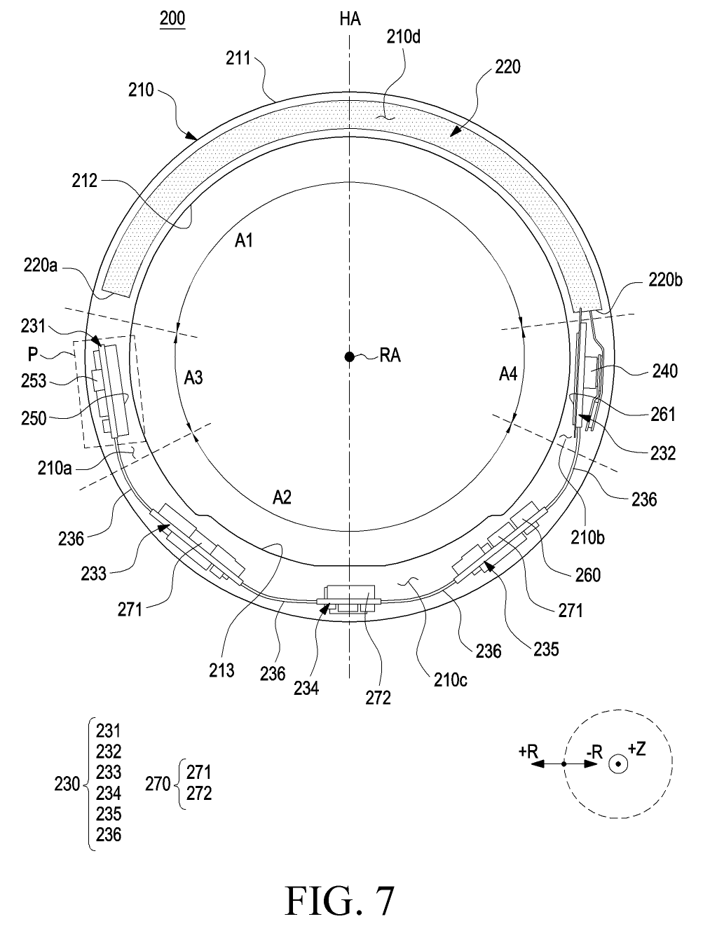

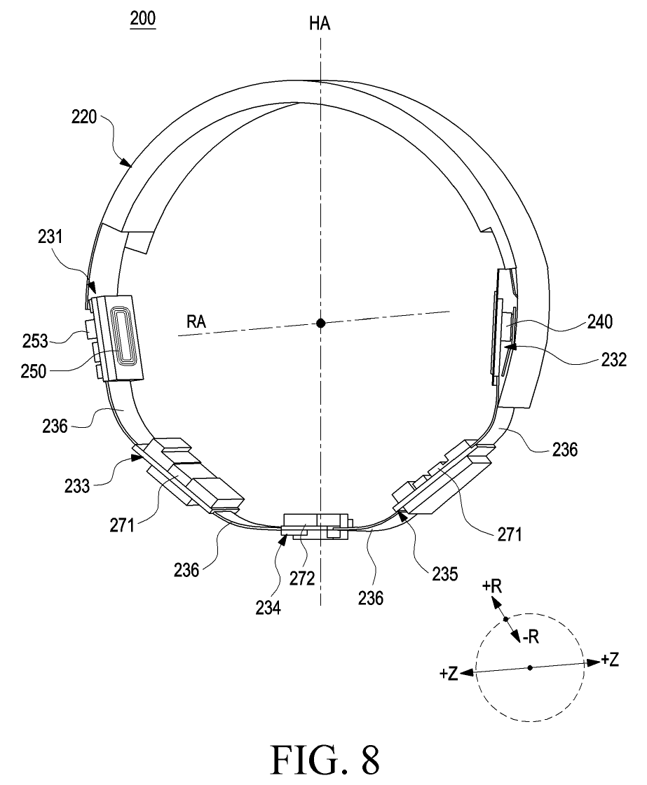

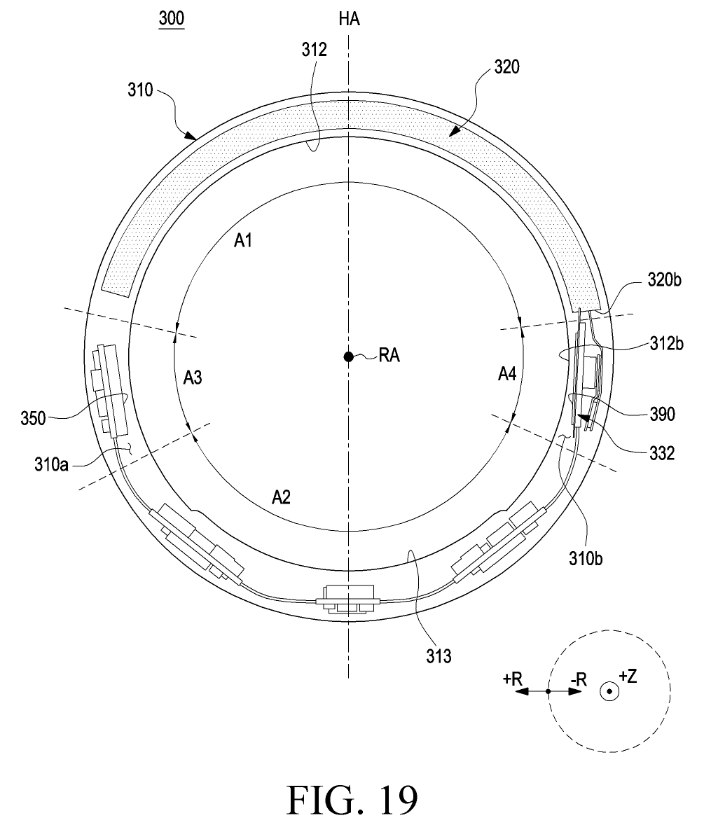

According to an embodiment, the inner housing part 212 may be a portion that contacts a user’s finger when the user wears the wearable electronic device 200. The inner housing part 212 may include a synthetic resin material (e.g., a plastic, resin, and/or epoxy). At least a portion of the inner housing part 212 may be formed to be transparent. For example, at least a portion of the inner housing part 212 at a portion facing a sensor (e.g., the sensor 270 of FIGS. 7 and 8), a first wireless charging coil (e.g., the first wireless charging coil 250 of FIGS. 7 and 8), or a second wireless charging coil (e.g., the second wireless charging coil 390 of FIG. 19) may be formed to be transparent. For example, the inner housing part 212 may be entirely formed to be transparent. According to an embodiment, at least a portion of the inner housing part 212 may include a material that is substantially the same as or similar to a material of the outer housing part 211. For example, at least a portion of the inner housing part 212 may include a metal material through which electricity may pass for biometric information measurement. For example, the inner housing part 212 may be formed of a metal material, and a portion facing a sensor (e.g., the sensor 270 of FIGS. 7 and 8), a first wireless charging coil (e.g., the first wireless charging coil 250 of FIGS. 7 and 8), or a second wireless charging coil (e.g., the second wireless charging coil 390 of FIG. 19) may be formed, at least in part, of a synthetic resin material (e.g., a plastic, resin, and/or epoxy).

According to an embodiment, the inner housing part 212 may be coupled to the outer housing part 211. For example, the inner housing part 212 may be coupled to the outer housing part 211 from an inner side of the outer housing part 211. According to an embodiment, the outer housing part 211 and the inner housing part 212 may be separately manufactured and assembled, or may be integrally formed. According to an embodiment, the outer housing part 211 may be manufactured of a metal material, and the inner housing part 212 may be formed by applying a liquid material to an inner side of the outer housing part 211 and curing the liquid material. In an embodiment, a portion of the inner housing part 212 may be implemented as a combination of a component made of a metal material or a synthetic resin and a portion formed by applying and curing a liquid material.

According to an embodiment, the outer housing part 211 and the inner housing part 212 may be coupled to each other, so that an inner space of the first housing 210 may be provided. The term “inner space of the first housing 210” may be understood as a space separate from an opening configured to accommodate a part of a user’s body (e.g., the hole H). For example, various electric/electronic components of the wearable electronic device 200 may be disposed and/or mounted in the inner space of the first housing 210. For example, the first housing 210 may accommodate various electric/electronic components.

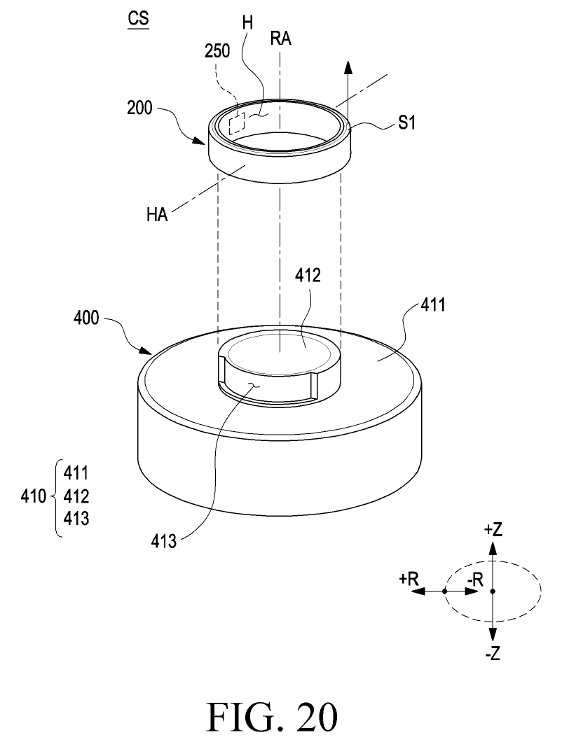

According to an embodiment, the first housing 210 may include a protrusion 213. The protrusion 213 may protrude from the inner housing part 212 in a direction toward the center of the ring shape (e.g., the inner radial direction (-R direction)). The protrusion 213 may be disposed in an area (e.g., a second housing area A2) that faces an area in which the battery 220 is disposed (e.g., a first housing area A1). The protrusion 213 may be disposed to face a fitting groove (e.g., the fitting groove 413 of FIGS. 20-23) when the wearable electronic device 200 is mounted on a charging device (e.g., the charging device 400 of FIGS. 20-23). For example, the protrusion 213 may be configured to be engaged with the fitting groove (e.g., the fitting groove 413 of FIGS. 20-23) when the wearable electronic device 200 is mounted on the charging device (e.g., the charging device 400 of FIGS. 20-23).

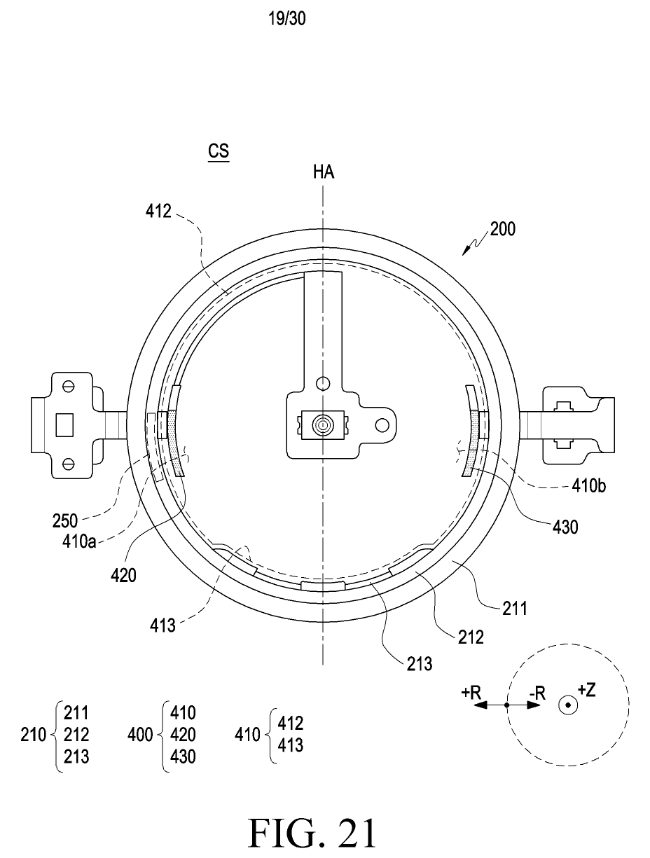

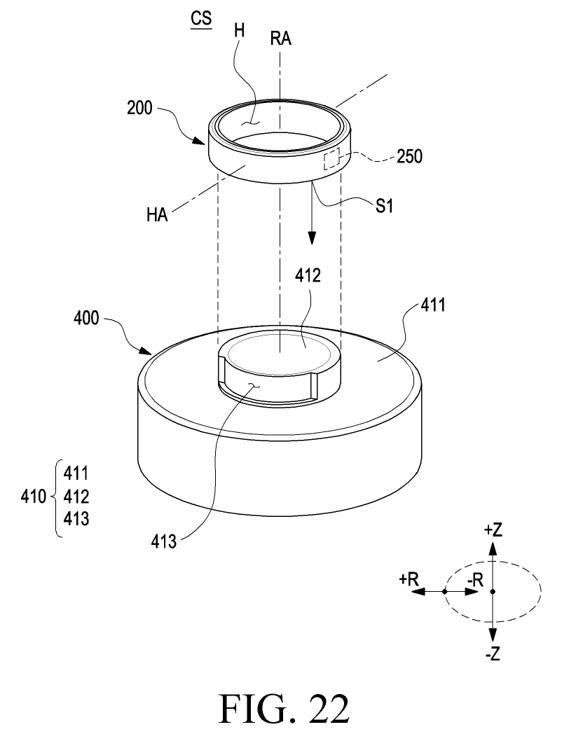

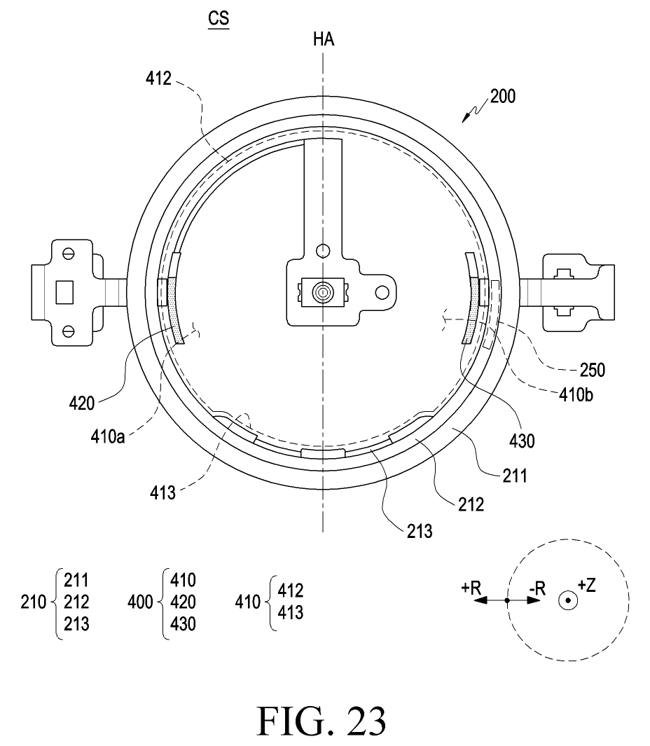

According to an embodiment, the protrusion 213 may have a shape that is substantially line-symmetric with respect to the horizontal axis HA. For example, referring to FIG. 6, the protrusion 213 may have a shape that is substantially left-right symmetric with respect to the horizontal axis HA. Accordingly, during a process in which the wearable electronic device 200 is seated on the charging device (e.g., the charging device 400 of FIGS. 20-23), the wearable electronic device 200 may be seated on the charging device in a normal orientation (e.g., the orientation of FIGS. 20 and 21 in which one surface S1 of the wearable electronic device 200 is oriented upward and the first wireless charging coil 250 faces the third wireless charging coil 420), or the wearable electronic device 200 may be seated on the charging device in an inverted orientation (e.g., the orientation of FIGS. 22 and 23 in which one surface S1 of the wearable electronic device 200 is oriented downward and the first wireless charging coil 250 faces the fourth wireless charging coil 430). Through this, charging convenience of the wearable electronic device 200 may be improved.

FIG. 7 is a cross-sectional view of a wearable electronic device according to various embodiments. FIG. 8 is a partial perspective view illustrating various components of the wearable electronic device 200 according to various embodiments.

FIG. 7 illustrates a first housing 210a cut such that an internal configuration of the wearable electronic device 200 is visible, and viewed in a first direction (+Z direction). FIG. 8 is a perspective view illustrating an internal configuration of the wearable electronic device 200 in a state in which the first housing 210 is removed.

The wearable electronic device 200 may include a battery 220, a first circuit board 231, a second circuit board 232, a third circuit board 233, a fourth circuit board 234, a fifth circuit board 235, a flexible circuit board 236, a connector 240, a first wireless charging coil 250, an electronic component 253, and a sensor 270. However, at least some of these components may be omitted, and additional components are not excluded.

According to an embodiment, the wearable electronic device 200 may include a first housing area A1. The first housing area A1 may be an area in which the battery 220 is disposed. The first housing area A1 may be an area that faces the protrusion 213 of the first housing 210. For example, the first housing area A1 may refer to an area (e.g., at least a portion of an upper region) that is oriented in approximately a 12 o’clock direction of the wearable electronic device 200 in FIG. 7.

According to an embodiment, the wearable electronic device 200 may include a second housing area A2. The second housing area A2 may be an area that faces the first housing area A1. The second housing area A2 may be an area in which the protrusion 213 is disposed. The second housing area A2 may be an area in which the third circuit board 233, the fourth circuit board 234, and/or the fifth circuit board 235 are disposed. For example, the second housing area A2 may refer to an area (e.g., at least a portion of a lower region) that is oriented in approximately a 6 o’clock direction of the wearable electronic device 200 in FIG. 7.

According to an embodiment, the wearable electronic device 200 may include a third housing area A3. The third housing area A3 may be a portion of an area between the first housing area A1 and the second housing area A2. The third housing area A3 may be an area in which the first circuit board 231 and/or the first wireless charging coil 250 is disposed. For example, the third housing area A3 may refer to an area oriented in approximately a 9-o’clock direction of the wearable electronic device 200, based on FIG. 7 (e.g., at least a portion of a left area).

According to an embodiment, the wearable electronic device 200 may include a fourth housing area A4. The fourth housing area A4 may be a portion of an area between the first housing area A1 and the second housing area A2. The fourth housing area A4 may be an area located at a position substantially line-symmetrical to the third housing area A3 with respect to the horizontal axis HA. The horizontal axis HA may refer to an axis passing through the center of a ring shape (e.g., a point through which the ring axis RA passes) and the protrusion 213. The fourth housing area A4 may be an area in which the second circuit board 232, the communication antenna 261, and/or the connector 240 is disposed. For example, the fourth housing area A4 may refer to an area oriented in approximately a 3-o’clock direction of the wearable electronic device 200, with reference to FIG. 7 (e.g., at least a portion of a right area).

In an embodiment, housing areas of the wearable electronic device 200 may be defined differently from those illustrated in the drawings, depending on the sizes or number of batteries and circuit boards.

According to an embodiment, the wearable electronic device 200 may include a first portion 210a. The first portion 210a may be a portion of an inner space of the first housing 210. The first portion 210a may be a portion adjacent to a first end portion 220a of the battery 220. For example, the first portion 210a may be a portion adjacent to the left end portion of the battery 220, with reference to FIG. 7. For example, the first portion 210a may be a portion, within a space in which the battery 220 is not disposed in the first housing 210, that is close to the first end portion 220a of the battery 220. The first portion 210a may at least partially correspond to the third housing area A3.

According to an embodiment, the wearable electronic device 200 may include a second portion 210b. The second portion 210b may be a portion of an inner space of the first housing 210. The second portion 210b may be adjacent to a second end portion 220b of the battery 220. For example, the second portion 210b may be a portion adjacent to the right end portion of the battery 220, with reference to FIG. 7. For example, the second portion 210b may be a portion within a space in which the battery 220 is not disposed in the first housing 210, that is close to the second end portion 220b of the battery 220. The second portion 210b may at least partially correspond to the fourth housing area A4.

According to an embodiment, the first portion 210a and the second portion 210b may be located at positions that are substantially line-symmetrical to each other with respect to the horizontal axis HA. For example, with reference to FIG. 7, the first portion 210a and the second portion 210b may be located at positions that are substantially left-right symmetrical to each other with respect to the horizontal axis HA.

According to an embodiment, the wearable electronic device 200 may include a third portion 210c. The third portion 210c may be a portion of an inner space of the first housing 210. The third portion 210c may be disposed between the first portion 210a and the second portion 210b. For example, the third portion 210c may be a portion disposed in an area, within the inner space of the first housing 210, that is oriented in a direction of approximately six o’clock (e.g., at least a portion of a lower area), with reference to FIG. 7. For example, the third portion 210c may be a portion, within the inner space of the first housing 210, that is opposite to a portion in which the battery 220 is disposed. The third portion 210c may at least partially correspond to the second housing area A2.

According to an embodiment, the wearable electronic device 200 may include a fourth portion 210d. The fourth portion 210d may be a portion of the inner space of the first housing 210. The fourth portion 210d may be disposed between the first portion 210a and the second portion 210b. For example, the fourth portion 210d may be a portion disposed in an area, within the inner space of the first housing 210, that is oriented in a direction of approximately twelve o’clock (e.g., at least a portion of an upper area), with reference to FIG. 7. For example, the fourth portion 210d may be a portion, within the inner space of the first housing 210, in which the battery 220 is disposed. The fourth portion 210d may at least partially correspond to the first housing area A1.

According to an embodiment, the wearable electronic device 200 may include a battery 220. The battery 220 may be disposed inside the first housing 210. The battery 220 may be disposed between the outer housing part 211 and the inner housing part 212. The battery 220 may be disposed in the first housing area A1. For example, the battery 220 may be disposed in the fourth portion 210d. For example, a length (e.g., an arc-shaped length) of the battery 220 may be smaller than one half of a circumferential length of the first housing 210. The battery 220 may be referred to as a curved battery.

According to an embodiment, the battery 220 may include a first end portion 220a and a second end portion 220b. The second end portion 220b may be an end portion of the battery 220 opposite to the first end portion 220a. For example, with reference to FIG. 7, the first end portion 220a may refer to a left end portion (e.g., a counterclockwise end portion) of the battery 220, and the second end portion 220b may refer to a right end portion (e.g., a clockwise end portion) of the battery 220.

According to an embodiment, the battery 220 may serve as a device configured to supply power to a component of the wearable electronic device 200, and may include a non-rechargeable primary battery, a rechargeable secondary battery, or a fuel cell. The battery 220 may be integrally disposed inside the wearable electronic device 200 or may be detachably disposed with respect to the wearable electronic device 200. According to an embodiment, the battery 220 may be implemented as a single integrated battery or may include a plurality of separable batteries. For example, the battery 220 may include a battery pack that is bent according to a shape of an inner space of the first housing 210. Alternatively, the battery 220 may include a plurality of battery packs that are not bent in the first housing 210. Alternatively, the battery 220 may include a battery pack that is bent and a plurality of battery packs that are not bent.

According to an embodiment, the wearable electronic device 200 may include a printed circuit board 230. Various electrical/electronic components may be disposed and/or mounted on the printed circuit board 230. For example, a processor (e.g., the processor 120 of FIG. 1 and/or the processor 205 of FIG. 3), memory (e.g., the memory 130 of FIG. 1 and/or the memory 206 of FIG. 3), a communication module (e.g., the communication module 190 of FIG. 1 and/or the communication circuit 207 of FIG. 3), or a sensor module (e.g., the sensor module 197 of FIG. 1) may be disposed on the printed circuit board 230.

According to an embodiment, the printed circuit board 230 may include a plurality of circuit boards (e.g., a first circuit board 231, a second circuit board 232, a third circuit board 233, a fourth circuit board 234, a fifth circuit board 235, and/or a flexible circuit board 236). The printed circuit board 230 may be configured such that rigid circuit boards (e.g., the first circuit board 231, the second circuit board 232, the third circuit board 233, the fourth circuit board 234, and/or the fifth circuit board 235) and flexible circuit boards 236 are alternately disposed along the circumference of the first housing 210.

According to an embodiment, the wearable electronic device 200 may include a first circuit board 231. The first circuit board 231 may be disposed in the third housing area A3. The first circuit board 231 may be disposed in the first portion 210a. The first circuit board 231 may be adjacent to the first end 220a of the battery 220. For example, with reference to FIG. 7, the first circuit board 231 may be disposed in a space, at a nine-o’clock direction, inside the first housing 210. For example, a first wireless charging coil 250 and/or at least one electronic component 253 may be disposed on the first circuit board 231. The first circuit board 231 may be a component of the printed circuit board 230. For example, the printed circuit board 230 may include the first circuit board 231.

According to an embodiment, the first circuit board 231 may be electrically connected to the second end 220b of the battery 220. For example, the first circuit board 231 may be electrically connected to the battery 220 through the third circuit board 233, the fourth circuit board 234, the fifth circuit board 235, and the second circuit board 232. For example, with reference to FIG. 7, the first circuit board 231 may be electrically connected to the battery 220 in a counterclockwise direction. The first circuit board 231 may not be electrically connected to the first end 220a of the battery 220. For example, with reference to FIG. 7, the first circuit board 231 may not be connected to the battery in a clockwise direction. According to an embodiment, in order to secure more battery capacity and efficiently use the inner space of the first housing 210, the first wireless charging coil 250 may be positioned on one surface of the first circuit board 231, a power management module (e.g., the electronic component 253) may be positioned on the other surface of the first circuit board 231, and the connector 240 that provides an electrical connection between the printed circuit board 230 and the battery 220 may be disposed on the second circuit board 232 that is disposed in the second portion 210b.

According to an embodiment, the wearable electronic device 200 may include a second circuit board 232. The second circuit board 232 may be disposed in the fourth housing area A4. The second circuit board 232 may be disposed in the second portion 210b. The second circuit board 232 may be adjacent to the second end 220b of the battery 220. For example, with reference to FIG. 7, the second circuit board 232 may be disposed in a space, at a three-o’clock direction, inside the first housing 210. The second circuit board 232 may be disposed at a position that is substantially line-symmetric with the first circuit board 231, with reference to the horizontal axis HA. The communication antenna 261 and/or the connector 240 may be disposed on the second circuit board 232. The second circuit board 232 may be a component of the printed circuit board 230. For example, the printed circuit board 230 may include the second circuit board 232.

According to an embodiment, the wearable electronic device 200 may further include additional circuit boards 233, 234, and 235. For example, the wearable electronic device 200 may include a third circuit board 233, a fourth circuit board 234, and/or a fifth circuit board 235. The third circuit board 233, the fourth circuit board 234, and/or the fifth circuit board 235 may be disposed in the second housing area A2. The third circuit board 233, the fourth circuit board 234, and/or the fifth circuit board 235 may be disposed in the third portion 210c. The third circuit board 233, the fourth circuit board 234, and/or the fifth circuit board 235 may be disposed between the first circuit board 231 and the second circuit board 232. The third circuit board 233, the fourth circuit board 234, and/or the fifth circuit board 235 may be disposed in an area facing the battery 220. The third circuit board 233, the fourth circuit board 234, and the fifth circuit board 235 may be sequentially disposed from the first circuit board 231 toward the second circuit board 232. For example, the third circuit board 233 may be disposed between the first circuit board 231 and the fourth circuit board 234, the fourth circuit board 234 may be disposed between the third circuit board 233 and the fifth circuit board 235, and the fifth circuit board 235 may be disposed between the fourth circuit board 234 and the second circuit board 232. The third circuit board 233, the fourth circuit board 234, and/or the fifth circuit board 235 may be a component of the printed circuit board 230. For example, the printed circuit board 230 may include the third circuit board 233, the fourth circuit board 234, and/or the fifth circuit board 235.

According to an embodiment, the wearable electronic device 200 may include a flexible circuit board 236. The flexible circuit board 236 may connect between respective rigid circuit boards (e.g., the first circuit board 231, the second circuit board 232, the third circuit board 233, the fourth circuit board 234, and the fifth circuit board 235). The flexible circuit board 236 may be configured to electrically connect the rigid circuit boards.

As described above, the wearable electronic device 200 may include the first circuit board 231, the second circuit board 232, the third circuit board 233, the fourth circuit board 234, the fifth circuit board 235, and the flexible circuit board 236. However, some of these components may be omitted, and the wearable electronic device 200 does not exclude inclusion of additional circuit boards.

According to an embodiment, the wearable electronic device 200 may include a connector 240. The connector 240 may be disposed in the fourth housing area A4. The connector 240 may be disposed in the second portion 210b. The connector 240 may be disposed on the second circuit board 232. For example, the connector 240 may be disposed on a surface of the second circuit board 232 that is oriented in the outer radial direction (+R direction). The connector 240 may be configured to electrically connect the second circuit board 232 and the battery 220. In an embodiment, the connector 240 may be disposed on a surface of the second circuit board 232 that is oriented in the inner radial direction (-R direction). In an embodiment, the connector 240 may be disposed in the third housing area A3. For example, the connector 240 may be disposed in the first portion 210a. For example, the connector 240 may be disposed on a surface of the first circuit board 231 that is oriented in the outer radial direction (+R direction) and/or on a surface that is oriented in the inner radial direction (-R direction). In this case, the connector 240 may be configured to electrically connect the first circuit board 231 and the battery 220. In an embodiment, the connector 240 may be disposed on both the first circuit board 231 and the second circuit board 232.

According to an embodiment, the wearable electronic device 200 may include a first wireless charging coil 250 (e.g., the coil 250 of FIG. 3). The first wireless charging coil 250 may be disposed in the third housing area A3. The first wireless charging coil 250 may be disposed in the first portion 210a that is adjacent to the first end 220a of the battery 220. For example, with reference to FIG. 7, the first wireless charging coil 250 may be disposed adjacent to the left end of the battery 220.

According to an embodiment, the first wireless charging coil 250 may be a near-field communication (NFC) charging coil. In an embodiment, the first wireless charging coil 250 may be a magnetic inductive charging coil, a magnetic resonant charging coil, and/or a coil used for a radio frequency charging scheme. According to an embodiment, the first wireless charging coil 250 may be referred to as an “RX coil” and/or an “RX antenna.”

According to an embodiment, the first wireless charging coil 250 may be disposed on one surface of the first circuit board 231. For example, the first wireless charging coil 250 may be disposed on a surface of the first circuit board 231 that is oriented in the inner radial direction (-R direction). For example, the first wireless charging coil 250 may be disposed on the first circuit board 231 to face the center of the ring shape (e.g., a point through which the ring axis RA passes). For example, the first wireless charging coil 250 may be disposed between the first circuit board 231 and the inner housing part 212.

According to an embodiment, it may be understood that the first wireless charging coil 250 is disposed in an area (e.g., the third housing area A3) different from an area in which the battery 220 is disposed (e.g., the first housing area A1). Through this, the thickness of the first housing 210 at a portion in which the battery 220, which has the greatest thickness among components disposed inside the first housing 210, is disposed may be reduced, and the overall thickness of the wearable electronic device 200 may be reduced.

According to an embodiment, the first wireless charging coil 250 may be configured to wirelessly charge the battery 220 through at least a portion of the inner housing part 212. For example, when the wearable electronic device 200 is seated on a charging device (e.g., the charging device 400 of FIGS. 20-23), the first wireless charging coil 250 may receive power while facing a third wireless charging coil (e.g., the third wireless charging coil 420 of FIGS. 21 and 23) or a fourth wireless charging coil (e.g., the fourth wireless charging coil 430 of FIGS. 21 and 23) of the charging device (e.g., the charging device 400 of FIGS. 20-23).

According to an embodiment, the wearable electronic device 200 may include at least one electronic component 253. The at least one electronic component 253 may be disposed on the other surface of the first circuit board 231. For example, the at least one electronic component 253 may be disposed on a surface of the first circuit board 231 that is oriented in the outer radial direction (+R direction). For example, the at least one electronic component 253 may be disposed on a side opposite to the first wireless charging coil 250 with reference to the first circuit board 231. For example, the at least one electronic component 253 may include a power management module (e.g., the power management module 188 of FIG. 1 and/or the power management circuit 204 of FIG. 3). As such, by a structure in which the first wireless charging coil 250 is disposed on one side (e.g., a side oriented in the inner radial direction (-R direction)) of the first circuit board 231, while the electronic component 253 is disposed on the other side (e.g., a side oriented in the outer radial direction (+R direction)) of the first circuit board 231, spatial efficiency (e.g., component mounting efficiency) for component arrangement on the first circuit board 231 may be improved.

According to an embodiment, the wearable electronic device 200 may include a communication circuit 260 (e.g., the communication module 190 of FIG. 1 and/or the communication circuit 207 of FIG. 3). The communication circuit 260 may be disposed on the printed circuit board 230. For example, the communication circuit 260 may be disposed on the fifth circuit board 235. For example, the communication circuit 260 may be disposed on a surface of the fifth circuit board 235 that is oriented in the inner radial direction (-R direction). In an embodiment, the communication circuit 260 may be disposed on a surface of the fifth circuit board 235 that is oriented in the outer radial direction (+R direction). In an embodiment, the communication circuit 260 may be disposed on another circuit board (e.g., the first circuit board 231, the second circuit board 232, the third circuit board 233, and/or the fourth circuit board 234).

According to an embodiment, the wearable electronic device 200 may include a communication antenna 261 (e.g., the antenna module 197 of FIG. 1). The communication antenna 261 may be disposed on the printed circuit board 230. For example, the communication antenna 261 may be disposed on the second circuit board 232. For example, the communication antenna 261 may be disposed on a surface of the second circuit board 232 that is oriented in the inner radial direction (-R direction). In an embodiment, the communication antenna 261 may be disposed on a surface of the second circuit board 232 that is oriented in the outer radial direction (+R direction). The communication antenna 261 may be disposed in the fourth housing area A4. The communication antenna 261 may be disposed at a portion (e.g., the second portion 210b) adjacent to the second end portion 220b of the battery 220. The communication antenna 261 may be configured to communicate with an external electronic device (e.g., S1 to S8 of FIG. 4) via the inner housing part 212. For example, the communication antenna 261 may include a Bluetooth antenna (e.g., a BT antenna).

According to an embodiment, referring to FIG. 7, the first wireless charging coil 250 and the communication antenna 261 may be respectively disposed at positions that are substantially line-symmetrical to each other with reference to the horizontal axis HA. For example, the first wireless charging coil 250 may be disposed in the first portion 210a and/or the third housing area A3, and the communication antenna 261 may be disposed in the second portion 210b, which is a portion formed at a position that is line-symmetrical to the first portion 210a with reference to the horizontal axis HA, and/or in the fourth housing area A4, which is an area that is line-symmetrical to the third housing area A3 with reference to the horizontal axis HA. For example, the communication antenna 261 may be disposed at a position that substantially faces the first wireless charging coil 250.

In an embodiment, the positions of the first wireless charging coil 250 and the communication antenna 261 may be interchanged with each other. For example, the first wireless charging coil 250 may be disposed in the fourth housing area A4, the second portion 210b, and/or on the second circuit board 232, and the communication antenna 261 may be disposed in the third housing area A3, the first portion 210a, and/or on the first circuit board 231.

According to an embodiment, the wearable electronic device 200 may include at least one sensor 270 (e.g., the sensor module 176 of FIG. 1). The at least one sensor 270 may be disposed in the third portion 210c located between the first portion 210a and the second portion 210b. For example, the at least one sensor 270 may be disposed on at least one of the third circuit board 233, the fourth circuit board 234, or the fifth circuit board 235. The at least one sensor 270 may be electrically connected to the printed circuit board 230 (e.g., the third circuit board 233, the fourth circuit board 234, and/or the fifth circuit board 235).

According to an embodiment, the at least one sensor 270 may be used as a sensor for acquiring (or measuring) biometric information. For example, the biometric information may include at least one of user blood oxygen saturation information, user heart rate information, or user blood glucose information. For example, the at least one sensor 270 may include a photo plethysmography (PPG) sensor for blood oxygen saturation measurement or heart rate measurement.

According to an embodiment, the at least one sensor 270 may include at least one light-emitting module 271. The at least one light-emitting module 271 may be disposed on at least one of the third circuit board 233, the fourth circuit board 234, or the fifth circuit board 235. For example, the at least one light emitting module 271 may be disposed on a surface of each of the third circuit board 233 and/or the fifth circuit board 235 that is oriented in the inner radial direction (-R direction).

According to an embodiment, the at least one light emitting module 271 may be a light-emitting module of the PPG sensor. For example, the at least one light-emitting module 271 may include a light source configured to emit light having two wavelength bands (e.g., a RED wavelength band or an infrared wavelength band). According to an embodiment, the at least one light-emitting module 271 may radiate light to a user’s body part (e.g., a finger, or the skin and/or a blood vessel of the finger) by emitting light beams having substantially the same or different wavelengths, respectively, to measure a user’s oxygen saturation. For example, the at least one light-emitting module 271 may emit light beams in various wavelength bands and may include at least one of a light-emitting diode (LED), a laser diode, or a vertical cavity surface emitting laser (VCSEL). The at least one light-emitting module 271 may be configured to sequentially (or repeatedly) emit light beams having different wavelength bands by dividing time.

According to an embodiment, the at least one sensor 270 may include at least one light-receiving module 272. The at least one light-receiving module 272 may be disposed on at least one of the third circuit board 233, the fourth circuit board 234, or the fifth circuit board 235. For example, the at least one light receiving module 272 may be disposed on a surface of the fourth circuit board 234 that is oriented in the inner radial direction (-R direction).

According to an embodiment, the at least one light-receiving module 272 may be a light-receiving module of the PPG sensor. For example, the at least one light-receiving module 272 may be configured to detect at least a portion of light reflected from, or transmitted through, a body part of a user (e.g., a finger, skin of the finger, or a blood vessel). The at least one light-receiving module 272 may be configured to receive light transmitted through a user’s body part, to convert the transmitted light into an electrical signal, and to transmit the electrical signal to a processor (e.g., the processor 120 of FIG. 1). The at least one light-receiving module 272 may accumulate photocharge corresponding to an amount of light reflected and/or transmitted and incident on a user’s body part and may convert a biometric signal in an analog current form according to the accumulated photocharge into a digital signal. For example, light (or an optical signal) acquired (or detected) through the at least one light-receiving module 272 may be converted through an ADC (analog-to-digital converter) and stored in a memory or a sensor buffer. At least one light-receiving module 272 may include at least one of a photodiode (PD), a photo transistor, a charge-coupled device (CCD), or a complementary metal oxide semiconductor (CMOS). The at least one light-receiving module 272 may include, without being limited thereto, various elements capable of converting an incident optical signal into an electrical signal.

According to an embodiment, light emitted from the at least one light-emitting module 271 may reach the at least one light-receiving module 272 through a light path. For example, the light path may be a path through which light is transmitted through a user’s body part (e.g., a finger, or the skin or a blood vessel of the finger) or a path through which light is reflected by the user’s body part. For example, at least a portion of light emitted from the light-emitting module 271 may pass through a user’s body or be reflected by the user’s body, and then reach the light-receiving module 272. The light-receiving module may receive light that has passed through, or has been reflected by, the user’s body, convert the received light into an electrical signal, and the converted electrical signal may be used as data for determining the user’s biometric information (e.g., oxygen saturation information or heart rate information).

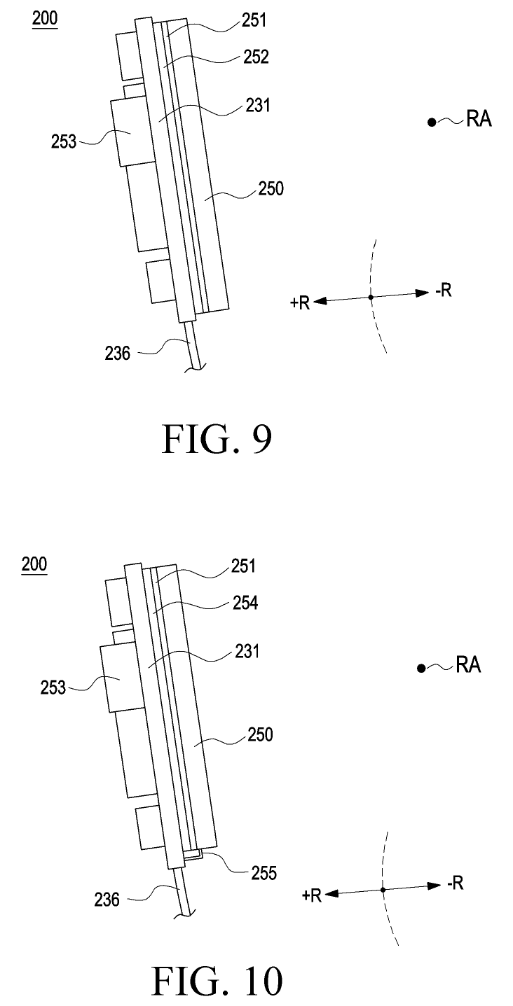

FIG. 9 is a diagram illustrating a side view of a portion of a configuration of a wearable electronic device according to various embodiments.

FIG. 9 is an enlarged view of portion P of FIG. 7 and illustrates an example of a portion in which the first circuit board 231 is disposed.

Detailed configurations of the wearable electronic device 200 that are not described below may be the same as or similar to the detailed configurations of the electronic device 101 described with reference to FIG. 1 and/or the detailed configurations of the wearable electronic device 200 described with reference to FIGS. 2-8.

According to an embodiment, the first wireless charging coil 250 may be disposed on one side of the first circuit board 231. For example, the first wireless charging coil 250 may be disposed on a side of the first circuit board 231 that is oriented in the inner radial direction (-R direction).

According to an embodiment, the wearable electronic device 200 may include shielding member 251. The shielding member 251 may be disposed on a side of the first wireless charging coil 250 that is oriented in the outer radial direction (+R direction). The shielding member 251 may be disposed on a side of the first circuit board 231 that is oriented in the inner radial direction (-R direction). For example, the shielding member 251 may be disposed between the first wireless charging coil 250 and the first circuit board 231. The shielding member 251 may reduce interference between the first wireless charging coil 250 and other peripheral components. The shielding member 251 may be referred to as a “shielding layer”, a “shield” and/or a “shielding sheet.”

According to an embodiment, the first wireless charging coil 250 may be electrically connected to the first circuit board 231. For example, the first wireless charging coil 250 may be connected to the first circuit board 231 in a surface-mounted device (SMD) type.

According to an embodiment, the wearable electronic device 200 may include a substrate 252. The substrate 252 may be disposed on a side of the first circuit board 231 that is oriented in the inner radial direction (-R direction). The substrate 252 may be disposed on a side of the shielding member 251 that is oriented in the outer radial direction (+R direction). For example, the substrate 252 may be disposed between the first circuit board 231 and the shielding member 251. The substrate 252 may be formed in the form of a printed circuit board. The substrate 252 may be mounted on the first circuit board 231 in a surface-mounted device (SMD) type. The substrate 252 may be electrically connected to the first circuit board 231. The first wireless charging coil 250 may be electrically connected to the substrate 252 through the shielding member 251. For example, the wearable electronic device 200 may include a via (not illustrated) configured such that one end thereof is connected to both terminals of the first wireless charging coil 250 and the other end thereof is connected to the substrate 252 while penetrating the shielding member 251, and the first wireless charging coil 250 may be electrically connected to the substrate 252 through the via (not illustrated). The first wireless charging coil 250 may be electrically connected to the first circuit board 231 via the substrate 252.

According to an embodiment, a maximum value of a combined thickness (e.g., a length in the inner radial direction (-R direction) and/or in the outer radial direction (+R direction)) of the first wireless charging coil 250, the first circuit board 231, the shielding member 251, the substrate 252, and the at least one electronic component 253 may be substantially equal to or less than a thickness (e.g., a length in the inner radial direction (-R direction) and/or in the outer radial direction (+R direction)) of the battery (e.g., the battery 220 of FIGS. 7 and 8). In an embodiment, a minimum value of a combined thickness (e.g., a length in the inner radial direction (-R direction) and/or in the outer radial direction (+R direction)) of the first wireless charging coil 250, the first circuit board 231, the shielding member 251, the substrate 252, and the at least one electronic component 253 may be smaller than the thickness (e.g., the length in the inner radial direction (-R direction) and/or in the outer radial direction (+R direction)) of the battery (e.g., the battery 220 of FIGS. 7 and 8). For example, a first circuit board assembly (e.g., the first circuit board 231, the first wireless charging coil 250, the shielding member 251, the substrate 252, and the at least one electronic component 253) may be understood to be at least substantially equal to or smaller than the thickness of the battery (e.g., the battery 220 of FIGS. 7 and 8). Accordingly, the thickness of the wearable electronic device 200 may be minimized/reduced to correspond to the thickness of the battery (e.g., the battery 220 of FIGS. 7 and 8).

According to an embodiment, the thickness of the substrate 252 may be substantially equal to or greater than the thickness of the shielding member 251. The thickness of the first wireless charging coil 250 may be greater than the thickness of the shielding member 251 and the thickness of the substrate 252. The thickness of the first circuit board 231 may be greater than the thickness of the first wireless charging coil 250. The thickness of a portion of the at least one electronic component 253 that has a greatest thickness may be substantially equal to or greater than a combined thickness of the shielding member 251, the substrate 252, and the first wireless charging coil 250.

FIG. 10 is a diagram illustrating a side view of a portion of a configuration of a wearable electronic device according to various embodiments.

FIG. 10 is an enlarged view of portion P of FIG. 7 and illustrates an example of a portion in which the first circuit board 231 is disposed.

According to an embodiment, the first wireless charging coil 250 may be electrically connected to the first circuit board 231. For example, the first wireless charging coil 250 may be of a flexible printed circuit board (FPCB) type and may be connected to the first circuit board 231.

According to an embodiment, the wearable electronic device 200 may include an attaching member 254. The attaching member 254 may be disposed on the inner radial direction (-R direction) side of the first circuit board 231. For example, the attaching member 254 may be disposed between the first circuit board 231 and the shielding member 251. The attaching member 254 may be configured to attach the shielding member 251 and/or the first wireless charging coil 250 to the first circuit board 231. For example, the attaching member 254 may be a double-sided tape and/or an adhesive.

According to an embodiment, the wearable electronic device 200 may include a connecting portion 255. One end of the connecting portion 255 may be connected to one side of the first wireless charging coil 250. The other end of the connecting portion 255 may be connected to the first circuit board 231. The connecting portion 255 may be configured to electrically connect the first wireless charging coil 250 and the first circuit board 231. In an embodiment, the connecting portion 255 may also be electrically connected to the flexible circuit board 236.

According to an embodiment, a maximum value of a combined thickness (e.g., a length in the inner radial direction (-R direction) and/or the outer radial direction (+R direction)) of the first wireless charging coil 250, the first circuit board 231, the shielding member 251, the attaching member 254, and at least one electronic component 253 may be substantially equal to or less than the thickness (e.g., a length in the inner radial direction (-R direction) and/or the outer radial direction (+R direction)) of a battery (e.g., the battery 220 of FIGS. 7 and 8). In an embodiment, a minimum value of a combined thickness (e.g., a length in the inner radial direction (-R direction) and/or the outer radial direction (+R direction)) of the first wireless charging coil 250, the first circuit board 231, the shielding member 251, the attaching member 254, and at least one electronic component 253 may be less than the thickness (e.g., a length in the inner radial direction (-R direction) and/or the outer radial direction (+R direction)) of the battery (e.g., the battery 220 of FIGS. 7 and 8). For example, a first circuit board assembly (e.g., the first circuit board 231, the first wireless charging coil 250, the shielding member 251, the substrate 252, and the at least one electronic component 253) may be understood to be at least substantially equal to or smaller than the thickness of the battery (e.g., the battery 220 of FIGS. 7 and 8). Accordingly, the thickness of the wearable electronic device 200 may be minimized/reduced to correspond to the thickness of the battery (e.g., the battery 220 of FIGS. 7 and 8).

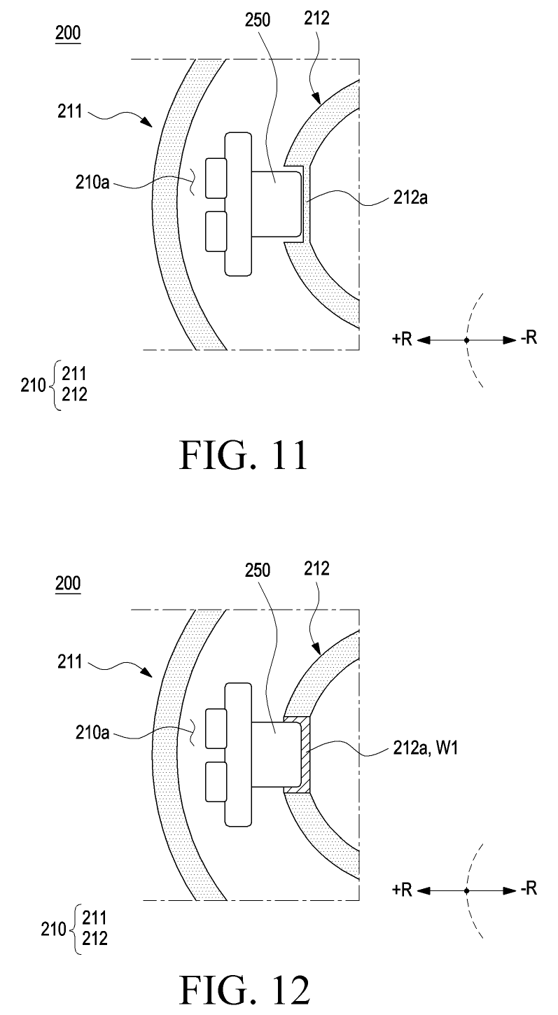

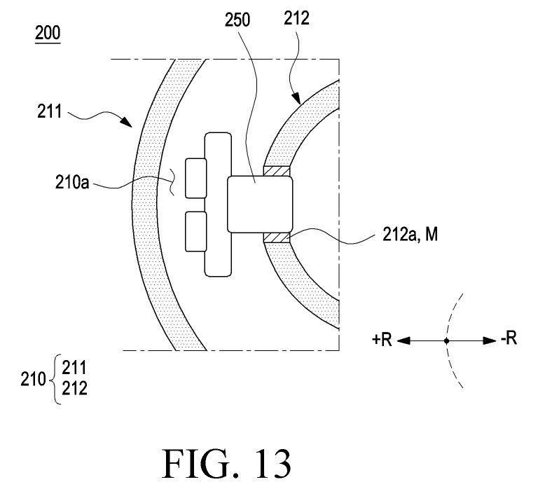

FIG. 11 is a diagram illustrating an enlarged view of a portion of a configuration of a wearable electronic device according to various embodiments. FIG. 12 is a diagram illustrating an enlarged view of a portion of a configuration of a wearable electronic device according to various embodiments. FIG. 13 is a diagram illustrating an enlarged view of a portion of a configuration of a wearable electronic device according to various embodiments.

FIGS. 11-13 are simplified schematic views obtained by enlarging a third housing area A3 of FIG. 7, and each of FIGS. 11-13 illustrates an example of the structure of the third housing area A3.

According to an embodiment, the inner housing part 212 may include a first charging part 212a. The first charging part 212a may be a portion of the inner housing part 212 and may be a portion corresponding to the first wireless charging coil 250. For example, the first charging part 212a may be a portion facing the first wireless charging coil 250.

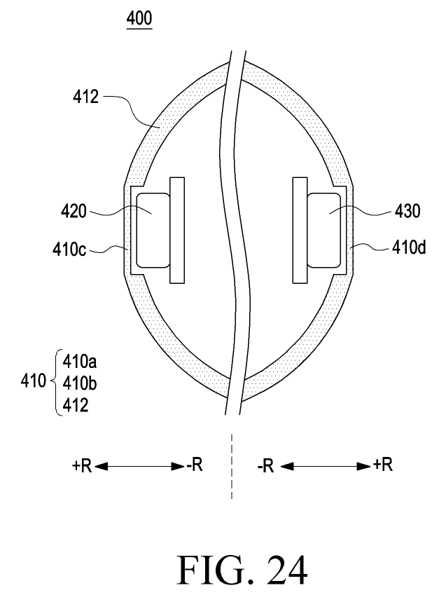

According to an embodiment, a surface (e.g., an outer circumferential surface) exposed to the outside of the first charging part 212a may be substantially planar. For example, a surface (e.g., an outer circumferential surface) of the first charging part 212a that is oriented in the inner radial direction (-R direction) may be substantially planar. According to an embodiment, an outer circumferential surface of a third charging part (e.g., the third charging device 410c of FIGS. 24-26) and/or a fourth charging part (e.g., the fourth charging device 410d of FIGS. 24-26) of a charging device (e.g., the charging device 400 of FIGS. 24-26), which is configured to face the first charging part 212a, may be substantially planar to correspond to the planar outer circumferential surface of the first charging part 212a. Through this, when the wearable electronic device 200 is seated on the charging device (e.g., the charging device 400 of FIGS. 20-26), the distance between the first wireless charging coil 250 and the third wireless charging coil (e.g., the third wireless charging coil 420 of FIGS. 21 and 23) or the fourth wireless charging coil (e.g., the fourth wireless charging coil 430 of FIGS. 21 and 23) may be reduced.

According to an embodiment (FIG. 11), the first charging part 212a of the inner housing part 212 and a portion of the inner housing part 212 adjacent to the first charging part 212a may include the same material. For example, the first charging part 212a and the portion of the inner housing part 212 adjacent to the first charging part 212a may be integrally formed. The first charging part 212a and the portion of the inner housing part 212 adjacent to the first charging part 212a may be formed of a synthetic resin material (e.g., a plastic, resin, and/or epoxy material).

According to an embodiment (FIG. 11), the thickness (e.g., a length in the inner radial direction (-R direction) and/or the outer radial direction (+R direction)) of the first charging part 212a may be smaller than the thickness (e.g., a length in the inner radial direction (-R direction) and/or the outer radial direction (+R direction)) of the portion of the inner housing part 212 adjacent to the first charging part 212a. Through this, when the wearable electronic device 200 is seated on a charging device (e.g., the charging device 400 of FIGS. 20-26), the first wireless charging coil 250 may be disposed at a position closer to a third wireless charging coil (e.g., the third wireless charging coil 420 of FIGS. 21 and 23) and/or a fourth wireless charging coil (e.g., the fourth wireless charging coil 430 of FIGS. 21 and 23) of the charging device (e.g., the charging device 400 of FIGS. 20-23). In an embodiment, the thickness of the first charging part 212a may be smaller than the thickness of a portion of an inner housing part 212 corresponding to a light-emitting module (e.g., the light-emitting module 271 of FIGS. 7 and 8) and/or a light-receiving module (e.g., the light-receiving module 273 of FIGS. 7 and 8). In an embodiment, the thickness of the first charging part 212a may be formed to be the smallest in the inner housing part 212.

According to an embodiment (FIG. 12), the first charging part 212a of the inner housing part 212 and the portion of the inner housing part 212 adjacent to the first charging part 212a may include different materials from each other. For example, the first housing 210 may include a first window part W1. The first window part W1 may be disposed in the first charging part 212a. The first window part W1 may include a material different from that of the portion of the inner housing part 212 adjacent to the first charging part 212a. For example, the portion of the inner housing part 212 adjacent to the first charging part 212a may include a metal material M, and the first window part W1 may include a synthetic resin material (e.g., a plastic, resin, and/or epoxy material). The first window part W1 may be referred to as a “window part.”

According to an embodiment (FIG. 12), the first wireless charging coil 250 may be disposed to be inserted, at least in part, into the first window part W1. For example, the first window part W1 may be disposed to surround at least a portion of the first wireless charging coil 250. For example, an end portion of the first wireless charging coil 250 that is oriented in the inner radial direction (-R direction) may be disposed closer to the inner radial direction (-R direction) than an end portion of the first window part W1 that is oriented in the outer radial direction (+R direction). Such a structure may be formed by inserting the first wireless charging coil 250 into the first window part W1 in a liquid state during a molding process of the first window part W1, and then curing the first window part W1; however, the present disclosure is not limited thereto. For example, a groove into which a portion of the first wireless charging coil 250 may be inserted may be formed in the first window part W1, and the first wireless charging coil 250 may be inserted into the groove. By disposing the first wireless charging coil 250 to be inserted, at least in part, into the first window part W1, when the wearable electronic device 200 is seated on a charging device (e.g., the charging device 400 of FIGS. 20-26), the first wireless charging coil 250 may be disposed at a position closer to a third wireless charging coil (e.g., the third wireless charging coil 420 of FIGS. 20 and 22) and/or a fourth wireless charging coil (e.g., the fourth wireless charging coil 430 of FIGS. 20 and 22) of the charging device (e.g., the charging device 400 of FIGS. 19-24).

According to an embodiment (FIG. 13), a portion of the first wireless charging coil 250 may protrude to the outside of the first housing 210. For example, a portion of the first wireless charging coil 250 may protrude from the inner housing part 212 in the inner radial direction (-R direction) through the inner housing part 212. A gap formed between the first wireless charging coil 250 and the inner housing part 212 may be sealed by a synthetic resin material (e.g., a plastic, resin, and/or epoxy material). Through this, when the wearable electronic device 200 is seated on a charging device (e.g., the charging device 400 of FIGS. 20-26), the first wireless charging coil 250 may be disposed at a position closer to a third wireless charging coil (e.g., the third wireless charging coil 420 of FIGS. 20 and 22) and/or a fourth wireless charging coil (e.g., the fourth wireless charging coil 430 of FIGS. 20 and 22) of the charging device (e.g., the charging device 400 of FIGS. 20 and 22).

In an embodiment (not illustrated), an outer housing part (e.g., the outer housing part 211 of FIGS. 11-13) may further include a synthetic resin material (e.g., a plastic and/or resin) and/or a ceramic material. For example, a portion of the outer housing part (e.g., the outer housing part 211 of FIGS. 11-13) may be formed of a synthetic resin material, and the remaining portion may be formed of a metal material. At a position (e.g., a facing position) within an inner space of a first housing (e.g., the first housing 210 of FIGS. 11-13) corresponding to a portion of the outer housing part (e.g., the outer housing part 211 of FIGS. 11-13) formed of the synthetic resin material, an antenna for communication (e.g., an NFC coil or a BT antenna) may be included. The communication antenna facing the outer housing part (e.g., the outer housing part 211 of FIGS. 11-13) may be configured to communicate with an external electronic device. A portion of the outer housing part (e.g., the outer housing part 211 of FIGS. 11-13) formed of the synthetic resin material may be referred to as a “window part.” For example, the communication antenna facing the outer housing part (e.g., the outer housing part 211 of FIGS. 11-13) may be configured to communicate with an external electronic device via the window part of the outer housing part (e.g., the outer housing part 211 of FIGS. 11-13). For example, the communication antenna facing the window part of the outer housing part 211 may be configured to wirelessly supply power to an external electronic device. For example, the communication antenna facing the window part of the outer housing part (e.g., the outer housing part 211 of FIGS. 11-13) may be configured to wirelessly receive power from an external electronic device. The communication antenna facing the window part of the outer housing part (e.g., the outer housing part 211 of FIGS. 11-13) may be disposed to be inserted, at least in part, into the window part of the outer housing part (e.g., the outer housing part 211 of FIGS. 11-13) similar to the structure of the first wireless charging coil illustrated in FIG. 12 (e.g., the first wireless charging coil 250 illustrated in FIG. 12). The communication antenna facing the window part of the outer housing part (e.g., the outer housing part 211 of FIGS. 11-13) may also be disposed to protrude, at least in part, to the outside of the first housing (e.g., the first housing 210 of FIGS. 11-13) through the window part, similar to the structure of the first wireless charging coil illustrated in FIG. 13 (e.g., the wireless charging coil 250 of FIG. 13).

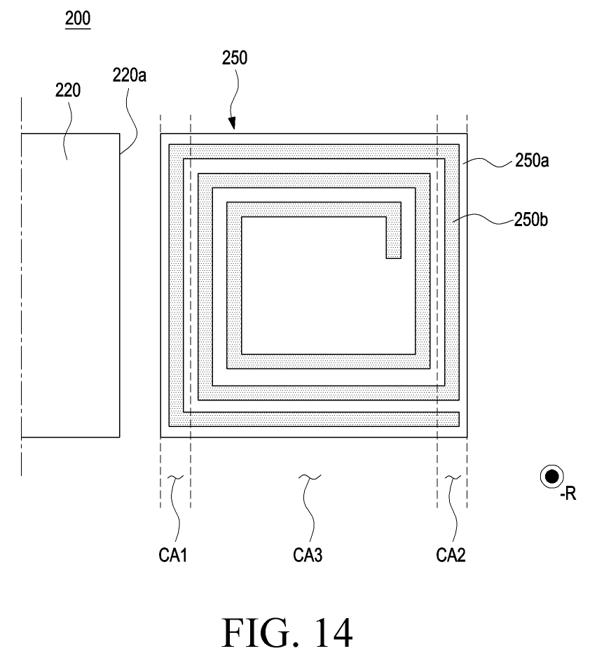

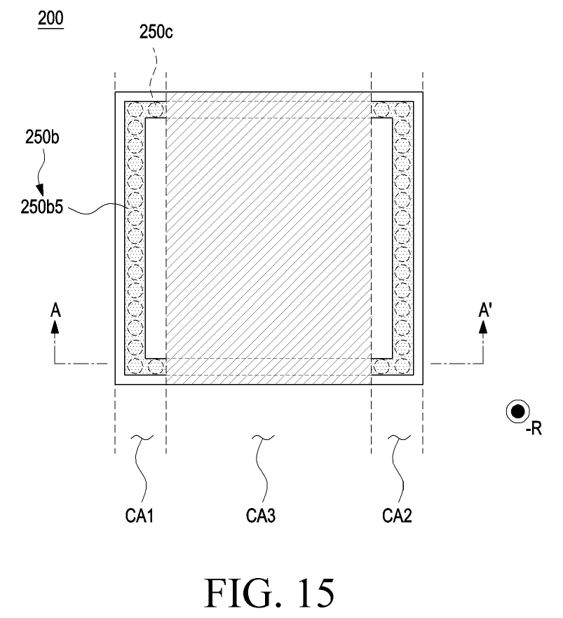

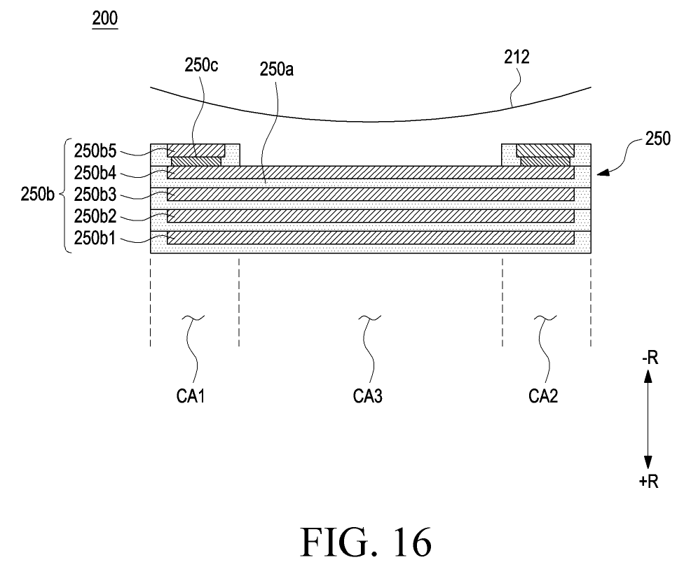

FIG. 14 is a diagram illustrating a plan view of a portion of a configuration of a wearable electronic device according to various embodiments. FIG. 15 is a diagram illustrating a plan view of a portion of the configuration of the wearable electronic device according to various embodiments. FIG. 16 is a cross-sectional view illustrating a portion of the configuration of a wearable electronic device according to various embodiments.

FIGS. 14-16 are simplified views illustrating a first wireless charging coil 250 and/or a peripheral configuration thereof. FIG. 14 illustrates the first wireless charging coil 250 and a battery 220 viewed in the inner radial direction (-R direction), FIG. 15 illustrates a five-layer portion (e.g., a fifth wiring layer 250b5) of the first wireless charging coil 250 viewed in the inner radial direction (-R direction), and FIG. 16 is a cross-sectional view taken along line A-A′ of FIG. 15.

Detailed configurations of the wearable electronic device 200 that are not described below may be the same as or similar to the detailed configurations of the electronic device 101 described with reference to FIG. 1 and/or the detailed configurations of the wearable electronic device 200 described with reference to FIGS. 2-13.

According to an embodiment, the first wireless charging coil 250 may include a wiring member 250b. The wiring member 250b may include a plurality of wiring layers 250b1, 250b2, 250b3, 250b4, and 250b5. For example, the wiring member 250b may include a first wiring layer 250b1, a second wiring layer 250b2, a third wiring layer 250b3, a fourth wiring layer 250b4, and a fifth wiring layer 250b5; however, some of the wiring layers may be omitted, and additional wiring layers are not excluded. The first wiring layer 250b1, the second wiring layer 250b2, the third wiring layer 250b3, and the fourth wiring layer 250b4 may be sequentially laminated from a side close to a first circuit board (e.g., the first circuit board 231 of FIGS. 9 and 10) toward a side distant therefrom. For example, the first wiring layer 250b1, the second wiring layer 250b2, the third wiring layer 250b3, and the fourth wiring layer 250b4 may be sequentially laminated in the inner radial direction (-R direction).

According to an embodiment, each of the first wiring layer 250b1, the second wiring layer 250b2, the third wiring layer 250b3, and the fourth wiring layer 250b4 may be wound in a spiral shape. For example, each of the first wiring layer 250b1, the second wiring layer 250b2, the third wiring layer 250b3, and the fourth wiring layer 250b4 may be wound in three turns. In an embodiment, the first wiring layer 250b1, the second wiring layer 250b2, the third wiring layer 250b3, and the fourth wiring layer 250b4 may be wound in the number of turns greater than three turns, or may be wound in the number of turns less than three turns.

According to an embodiment, the first wireless charging coil 250 may include a sheet member 250a. The sheet member 250a may be disposed between respective ones of the plurality of wiring layers (e.g., the first wiring layer 250b1, the second wiring layer 250b2, the third wiring layer 250b3, the fourth wiring layer 250b4, and the fifth wiring layer 250b5). The sheet member 250amay include an insulating material. The plurality of wiring layers 250b1, 250b2, 250b3, 250b4, and 250b5 may be electrically connected to one another through vias (not illustrated) extending through the sheet member 250a.

According to an embodiment, the first wireless charging coil 250 may include a first coil area CA1. The first coil area CA1 may refer to an area close to a first end portion 220a of the battery 220. The first wireless charging coil 250 may include a second coil area CA2. The second coil area CA2 may refer to an area close to a second end portion 220b of the battery 220. The first wireless charging coil 250 may include a third coil area CA3. The third coil area CA3 may refer to an area between the first coil area CA1 and the second coil area CA2.

According to an embodiment, a lamination thickness of the first wireless charging coil 250 (e.g., the wiring member 250b) in at least a portion of an outer region of the first wireless charging coil 250 may be greater than a lamination thickness of the first wireless charging coil 250 (e.g., the wiring member 250b) in a central region of the first wireless charging coil 250. For example, a lamination thickness of the first wireless charging coil 250 (e.g., the wiring member 250b) in at least one of the first coil area CA1 or the second coil area CA2 may be greater than a lamination thickness of the first wireless charging coil 250 (e.g., the wiring member 250b) in the third coil area CA3. For example, a lamination thickness of the first wireless charging coil 250 (e.g., the wiring member 250b) in the first coil area CA1 and the second coil area CA2 may be greater than a lamination thickness of the first wireless charging coil 250 (e.g., the wiring member 250b) in the third coil area CA3. The inner housing part 212 may have a curved shape, and by forming a lamination thickness of the first wireless charging coil 250 (e.g., the wiring member 250b) in an outer region (e.g., the first coil area CA1 and/or the second coil area CA2) of the first wireless charging coil 250 to be greater than a lamination thickness of the first wireless charging coil 250 in a central region (e.g., the third coil area CA3) of the first wireless charging coil 250, it may be possible to prevent and/or reduce a distance between the first wireless charging coil 250 (e.g., the wiring member 250b) in the outer region of the first wireless charging coil 250 and a TX coil (e.g., the third wireless charging coil 420 and/or the fourth wireless charging coil 430 of FIGS. 21 and 23) from becoming greater, and thus wireless charging efficiency may be improved.

According to an embodiment, the number of laminated layers of the first wireless charging coil 250 in at least one of the first coil area CA1 or the second coil area CA2 may be greater than the number of laminated layers of the first wireless charging coil 250 in the third coil area CA3. For example, the wiring member 250b may include a fifth wiring layer 250b5. The fifth wiring layer 250b5 may be disposed in the first coil area CA1 and/or the second coil area CA2. The fifth wiring layer 250b5 may be disposed on the fourth wiring layer 250b4. For example, the number of laminated wiring layers (e.g., five layers) in the first coil area CA1 and the second coil area CA2 may be greater by at least one layer than the number of laminated wiring layers (e.g., four layers) in the third coil area CA3. The fifth wiring layer 250b5 may be electrically connected to the fourth wiring layer 250b4 by vias 250c penetrating the sheet member 250a disposed between the fifth wiring layer 250b5 and the fourth wiring layer 250b4. The fifth wiring layer 250b5 may not form a separate number of winding turns. For example, the fifth wiring layer 250b5 may be understood as a configuration that merely increases a thickness of a portion of the fourth wiring layer 250b4 disposed in the first coil area CA1 and the second coil area CA2. Through such a structure, since the thickness of the wiring member 250b at the uppermost layer in the first coil area CA1 and/or the second coil area CA2 may increase, the resistance value of the wiring member 250b may be reduced, and accordingly, a Q value (e.g., a quality factor) may be improved.

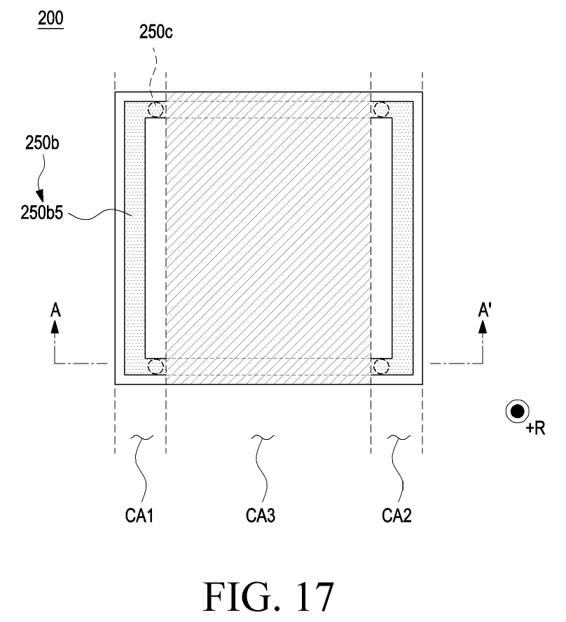

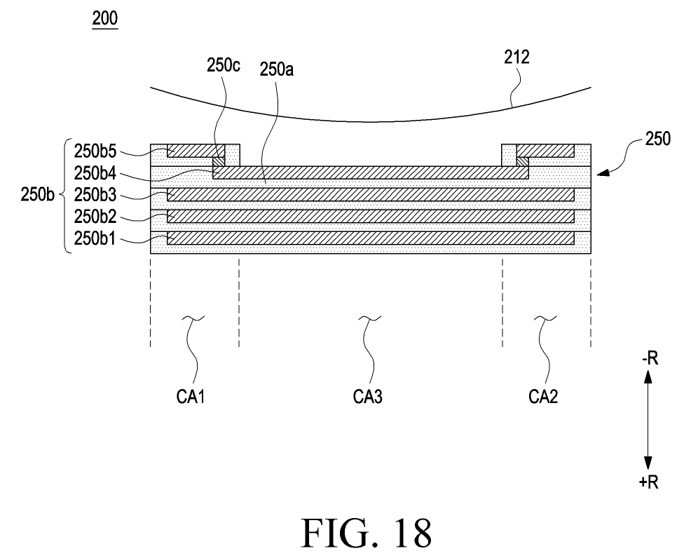

FIG. 17 is a diagram illustrating a plan view of a portion of the configuration of a wearable electronic device according to various embodiments. FIG. 18 is a cross-sectional view illustrating a portion of the configuration of a wearable electronic device according to various embodiments.

FIGS. 17 and 18 are simplified views illustrating a structure of the first wireless charging coil 250, in which FIG. 17 illustrates a portion of a five-layer portion (e.g., a fifth wiring layer 250b5) of the first wireless charging coil 250, viewed in the inner radial direction (-R direction), and FIG. 18 is a cross-sectional view taken along line A-A′ of FIG. 17.

Detailed configurations of the wearable electronic device 200 that are not described below may be the same as or similar to the detailed configurations of the electronic device 101 described with reference to FIG. 1 and/or the detailed configurations of the wearable electronic device 200 described with reference to FIGS. 2-16.

According to an embodiment, the number of laminated layers of the first wireless charging coil 250 in at least one of the first coil area CA1 or the second coil area CA2 may be equal to the number of laminated layers of the first wireless charging coil 250 in the third coil area CA3. For example, the wiring member 250b may include a fifth wiring layer 250b5. The fifth wiring layer 250b5 may be disposed in the first coil area CA1 and the second coil area CA2. In at least a portion of an area (e.g., the first coil area CA1 and the second coil area CA2) in which the fifth wiring layer 250b5 is disposed, the fourth wiring layer 250b4 may not be disposed. For example, the number of laminated wiring layers (e.g., four layers) in the first coil area CA1 and the second coil area CA2 may be equal to the number of laminated wiring layers (e.g., four layers) in the third coil area CA3. The fifth wiring layer 250b5 may be electrically connected to the fourth wiring layer 250b4 disposed in the third coil area CA3 by vias 250c penetrating the sheet member 250a disposed between the fifth wiring layer 250b5 and the fourth wiring layer 250b4. For example, the fifth wiring layer 250b5 may be a portion extending from the fourth wiring layer 250b4. For example, the fifth wiring layer 250b5 may be understood as a portion in which wiring laminated on a fourth layer (e.g., the fourth wiring layer 250b4) in the third coil area CA3 extends to a fifth layer through the vias 250c in the first coil area CA1 and the second coil area CA2. The fifth wiring layer 250b5 may form a total of three winding turns together with the fourth wiring layer 250b4.

FIG. 19 is a cross-sectional view of a wearable electronic device according to various embodiments.

FIG. 19 illustrates a first housing 310 cut such that an internal configuration of a wearable electronic device 300 is visible.

Detailed configurations of the wearable electronic device 300 that are not described below may be the same as or similar to the detailed configurations of the wearable electronic device 101 described with reference to FIG. 1 and/or the detailed configurations of the wearable electronic device 200 described with reference to FIGS. 2-18.

According to an embodiment, the wearable electronic device 300 may include a second wireless charging coil 390 (e.g., the coil 250 of FIG. 3). The second wireless charging coil 390 may be disposed in a fourth housing area A4 (e.g., the fourth housing area A4 of FIG. 7). The second wireless charging coil 390 may be disposed in a second portion 310b (e.g., the second portion 210b of FIG. 7) adjacent to a second end portion 320b (e.g., the second end portion 230b of FIG. 7) of a battery 320. For example, with reference to FIG. 19, the second wireless charging coil 390 may be disposed adjacent to a right end portion of the battery 320 (e.g., the battery 220 of FIGS. 7 and 8). The second wireless charging coil 390 may be a wireless charging coil additionally provided with respect to a first wireless charging coil 350 (e.g., the first wireless charging coil 250). A charging scheme of the wearable electronic device 300 including the first wireless charging coil 350 and the second wireless charging coil 390 may be referred to as a “dual coil charging” scheme.

According to an embodiment, the second wireless charging coil 390 may be disposed on a second circuit board 332 (e.g., the second circuit board 232 of FIGS. 7 and 8). For example, the second wireless charging coil 390 may be disposed on the inner radial direction (-R direction) side of the second circuit board 332. For example, the second wireless charging coil 390 may be disposed on the second circuit board 332 to face a center of a ring shape (e.g., a point through which a ring axis RA passes). For example, the second wireless charging coil 390 may be disposed between the second circuit board 332 and an inner housing part 312.

According to an embodiment, the first wireless charging coil 350 and the second wireless charging coil 390 may be disposed at positions that are substantially line-symmetrical to each other with respect to a horizontal axis HA passing through the center of the ring shape (e.g., a point through which a ring axis RA passes) and the center of a protrusion 313 (e.g., the protrusion 213 of FIGS. 5-7). For example, the first wireless charging coil 350 may be disposed in a first portion 310a (e.g., the first portion 210a of FIG. 7) and/or a third housing area A3 (e.g., the third housing area A3 of FIG. 7), and the second wireless charging coil 390 may be disposed in a second portion 310b, which is a portion formed at a position substantially line-symmetrical to the first portion 310a with respect to the horizontal axis HA, and/or in a fourth housing area A4, which is an area line-symmetrical to the third housing area A3 with respect to the horizontal axis HA. For example, the first wireless charging coil 350 and the second wireless charging coil 390 may be disposed at positions facing each other with respect to the horizontal axis HA. Through this, when the wearable electronic device 300 is seated on a charging device (e.g., the charging device 400 of FIGS. 20-25) in a normal orientation (e.g., the orientation of FIGS. 20 and 21, in which the first wireless charging coil 250 faces a third wireless charging coil 420), the first wireless charging coil 350 may face a third wireless charging coil (e.g., the third wireless charging coil 420 of FIGS. 21 and 23), and the second wireless charging coil 390 may face a fourth wireless charging coil (e.g., the fourth wireless charging coil 430 of FIGS. 21 and 23). Further, even when the wearable electronic device 300 is seated on the charging device (e.g., the charging device 400 of FIGS. 20-25) in an inverted orientation (e.g., the orientation of FIGS. 22 and 23, in which the first wireless charging coil 250 faces the fourth wireless charging coil 430), the first wireless charging coil 350 may face the fourth wireless charging coil (e.g., the fourth wireless charging coil 430 of FIGS. 21 and 23), and the second wireless charging coil 390 may face the third wireless charging coil (e.g., the third wireless charging coil 420 of FIGS. 21 and 23). For example, regardless of the direction in which the wearable electronic device 300 is seated on a charging device (e.g., the charging device 400 of FIGS. 20-25), a dual coil charging scheme may be implemented.

According to an embodiment, the second wireless charging coil 390 may be a near-field communication (NFC) charging coil. In an embodiment, the second wireless charging coil 390 may be a magnetic inductive charging coil, a magnetic resonant charging coil, and/or a coil used for radio frequency charging scheme. According to an embodiment, the second wireless charging coil 390 may be referred to as an “RX coil” and/or an “RX antenna.”

According to an embodiment, the second wireless charging coil 390 may be disposed on the second circuit board 332. For example, the second wireless charging coil 390 may be disposed on the inner radial direction (-R direction) side of the second circuit board 332. For example, the second wireless charging coil 390 may be disposed on the second circuit board 332 to face a center of a ring shape (e.g., a point through which a ring axis RA passes).

According to an embodiment, it may be understood that the second wireless charging coil 390 is disposed in an area (e.g., the fourth housing area A4) different from an area in which the battery 320 is disposed (e.g., the first housing area A1). Through this, the thickness of a first housing 310 (e.g., the housing 210 of FIGS. 5 to 7) at a portion in which the battery 320, which has the greatest thickness among components disposed inside the first housing 310, is disposed may be reduced, and the overall thickness of the wearable electronic device 300 may be reduced.

According to an embodiment, the second wireless charging coil 390 may be configured to wirelessly charge the battery 320 via at least a portion of an inner housing part 312 (e.g., the inner housing part 212 of FIGS. 5-7). For example, when the wearable electronic device 300 is seated on a charging device (e.g., the charging device 400 of FIGS. 20-25), the second wireless charging coil 390 may face a third wireless charging coil (e.g., the third wireless charging coil 420 of FIGS. 20 and 22) or a fourth wireless charging coil (e.g., the fourth wireless charging coil 430 of FIGS. 20 and 22) of the charging device (e.g., the charging device 400 of FIGS. 19-22), and may receive power.

According to an embodiment, the inner housing part 312 may include a second charging part 312b. The second charging part 312b may be a portion of the inner housing part 312 and may be a portion corresponding to the second wireless charging coil 390. For example, the second charging part 312b may be a portion facing the second wireless charging coil 390.

According to an embodiment, the second charging part 312b may have a structure that is the same as or similar to a structure of the first charging part (e.g., the first charging part 212a of FIGS. 11-13).

For example, equally or similarly to the structure of the first charging part (e.g., the first charging part 212a of FIG. 11) illustrated in FIG. 11, a surface (e.g., an outer circumferential surface) of the second charging part 312b that is exposed to the outside may be substantially planar. For example, a surface (e.g., an inner circumferential surface) of the second charging part 312b that faces the second wireless charging coil 390 may be substantially planar. For example, the second charging part 312b may include the same material as a portion of the inner housing part 312 adjacent to the second charging part 312b (e.g., a synthetic resin material such as a plastic, resin, and/or epoxy material). For example, the second charging part 312b and the portion of the inner housing part 312 adjacent to the second charging part 312b may be integrally formed.

For example, equally or similarly to the structure of the first charging part (e.g., the first charging part 212a of FIG. 12) illustrated in FIG. 12, the second charging part 312b and the portion of the inner housing part 312 adjacent to the second charging part 312b may include different materials. For example, the first housing 310 may include a second window part (not illustrated). The portion of the inner housing part 312 adjacent to the second charging part 312b may include a metal material, and the second window part may include a synthetic resin material (e.g., a plastic, resin, and/or epoxy material). For example, the second wireless charging coil 390 may be disposed to be inserted, at least in part, into the second window part.

For example, equally or similarly to the structure of the first charging part (e.g., the first charging part 212a of FIG. 13) illustrated in FIG. 13, a portion of the second wireless charging coil 390 may protrude to the outside of the first housing 210. For example, a portion of the second wireless charging coil 390 may protrude from the inner housing part 312 in the inner radial direction (-R direction) through the inner housing part 312. A gap formed between the second wireless charging coil 390 and the inner housing part 312 may be sealed by a synthetic resin material (e.g., a plastic, resin, and/or epoxy material).

FIG. 20 is a perspective view of a charging system according to various embodiments. FIG. 21 is a diagram illustrating a plan view of the charging system according to various embodiments. FIG. 22 is a perspective view of the charging system according to various embodiments. FIG. 23 is a diagram illustrating a plan view of the charging system according to various embodiments.

FIG. 20 is a perspective view of a wearable electronic device 200 and a charging device 400, and illustrates a process in which the wearable electronic device 200 is fitted onto and/or detached from the charging device 400 in a normal orientation (e.g., an orientation in which one surface S1 of the wearable electronic device 200 is oriented in a first direction (+Z direction)). FIG. 21 illustrates a state in which the wearable electronic device 200 is seated on the charging device 400 in a normal orientation, and illustrates the charging system CS as viewed in the first direction (+Z direction), with an internal configuration of the charging device 400 being illustrated as visible through a second housing 410. FIG. 22 is a perspective view of the wearable electronic device 200 and the charging device 400, and illustrates a process in which the wearable electronic device 200 is fitted onto and/or detached from the charging device 400 in an inverted orientation (e.g., an orientation in which one surface S1 of the wearable electronic device 200 is oriented in a second direction (-Z direction)). FIG. 23 illustrates a state in which the wearable electronic device 200 is seated on the charging device 400 in the inverted orientation, and illustrates the charging system CS as viewed from the first direction (+Z direction), in which an internal configuration of the charging device 400 is illustrated to be visible through the second housing 410.

Detailed configurations of the wearable electronic device 200 that are not described below may be the same as or similar to the detailed configurations of the electronic device 101 described with reference to FIG. 1, the detailed configurations of the wearable electronic device 200 described with reference to FIGS. 2-18, and/or the detailed configurations of the wearable electronic device 300 described with reference to FIG. 19.

Detailed configurations of the charging device 400 that are not described below may be the same as or similar to the detailed configurations of the charging device 400 described with reference to FIGS. 2 and 3.

According to an embodiment, referring to FIGS. 20 and 21, the wearable electronic device 200 may be seated on the charging device 400 (e.g., the seating portion 412) in a normal orientation. The term “normal orientation” may refer to an orientation in which one surface S1 of the wearable electronic device 200 is oriented upward (e.g., in the first direction (+Z direction)) and/or an orientation in which, when the wearable electronic device 200 is seated on the charging device 400, the first wireless charging coil 250 faces the third wireless charging coil 420.

According to an embodiment, referring to FIGS. 22 and 23, the wearable electronic device 200 may be seated on the charging device 400 (e.g., the seating portion 412) in an inverted orientation. The term “inverted orientation” may refer to an orientation in which the one surface S1 of the wearable electronic device 200 is oriented downward (e.g., in the second direction (-Z direction)) and/or an orientation in which, when the wearable electronic device 200 is seated on the charging device 400, the first wireless charging coil 250 faces the fourth wireless charging coil 430. The “inverted orientation” of the wearable electronic device 200 may refer to an orientation in which the wearable electronic device 200 is flipped from the “normal orientation” by being rotated with respect to the horizontal axis HA. According to an embodiment, when viewed from the first direction (+Z direction), since a first housing (e.g., the first housing 210 of FIGS. 5 and 6) and a protrusion 213 of the wearable electronic device 200 have a substantially left-right symmetrical shape with respect to the horizontal axis HA, and a seating portion 412 and a fitting groove 413 of the charging device 400 also have a substantially left-right symmetrical shape with respect to the horizontal axis HA, the wearable electronic device 200 may be seated on the charging device 400 regardless of whether the wearable electronic device 200 is in the normal orientation or in the inverted orientation.

According to an embodiment, the charging device 400 may include a second housing 410. The second housing 410 may form an overall exterior appearance of the charging device 400. Inside the second housing 410, a battery, a printed circuit board, an RX coil configured to charge the battery, a power supply circuit (e.g., the power supply circuit 404 of FIG. 3), a processor (e.g., the processor 403 of FIG. 3), a power management module (e.g., the PMIC 403a of FIG. 3), a communication circuit (e.g., the communication circuit 401 of FIG. 3), a transmitter (e.g., the transmitter 401a of FIG. 3), an input interface (e.g., the input interface 405 of FIG. 3), a Hall IC (e.g., the Hall IC 406 of FIG. 3), a matching circuit (e.g., the matching circuit 402 of FIG. 3), a third wireless charging coil 420, and/or a fourth wireless charging coil 430 may be disposed. The second housing 410 of the charging device 400 may be referred to as a “housing.”

According to an embodiment, the second housing 410 may include a base part 411. The base part 411 may form a lower region (e.g., the second direction (-Z-direction) side area) of the second housing 410. The base part 411 may be larger than the wearable electronic device 200 when viewed from the first direction (+Z direction). The base part 411 may be a portion that supports the wearable electronic device 200 in a direction (e.g., the first direction (+Z direction)) opposite to a gravitational direction (e.g., the second direction (-Z direction)) when the wearable electronic device 200 is seated on the charging device 400.

According to an embodiment, the second housing 410 may include a seating portion 412. The seating portion 412 may be a portion that protrudes upward (e.g., in the first direction (+Z direction)) from a central region of the base part 411. The seating portion 412 may have a substantially cylindrical shape. The seating portion 412 may be smaller than the wearable electronic device 200 when viewed in the first direction (+Z direction). During a process in which the wearable electronic device 200 is seated on the charging device 400, the seating portion 412 may be inserted into a hole H of the wearable electronic device 200. The seating portion 412 may be a portion that supports the wearable electronic device 200 in a radial direction when the wearable electronic device 200 is seated on the charging device 400. A shape of an outer circumferential surface of the seating portion 412 may at least partially correspond to a surface of the wearable electronic device 200 facing a ring axis RA.

According to an embodiment, the second housing 410 may include a fitting groove 413. The fitting groove 413 may be formed recessed from the seating portion 412. A protrusion 213 of the wearable electronic device 200 may be seated in the fitting groove 413. The fitting groove 413 may have a shape corresponding to the shape of the protrusion 213 of the wearable electronic device 200. During a process in which the wearable electronic device 200 is seated on the charging device 400, the protrusion 213 of the wearable electronic device 200 may be brought into engagement with the fitting groove 413 of the charging device 400, so that a seating direction of the wearable electronic device 200 may be guided. For example, by the protrusion 213 being brought into engagement with the fitting groove 413, the first wireless charging coil 250 of the wearable electronic device 200 may face the third wireless charging coil 420 and/or the fourth wireless charging coil 430 of the charging device 400.

According to an embodiment, the charging device 400 may include a fifth portion 410a. The fifth portion 410a may be a portion of an inner space of the second housing 410 (e.g., the seating portion 412). The fifth portion 410a may be a portion corresponding to the first wireless charging coil 250, a first portion (e.g., the first portion 210a of FIG. 7), and/or a third housing area (e.g., the third housing area A3 of FIG. 7) of the wearable electronic device 200 when the wearable electronic device 200 is inserted and/or seated at the seating portion 412 such that one surface S1 of the wearable electronic device 200 is oriented in the first direction (+Z direction) (e.g., the state of FIGS. 20 and 21 in which the wearable electronic device 200 is fitted onto the seating portion 412 in the normal orientation).

According to an embodiment, the charging device 400 may include a sixth portion 410b. The sixth portion 410b may be a portion of an inner space of the second housing 410 (e.g., the seating portion 412). The sixth portion 410b may be a portion corresponding to the first wireless charging coil 250, the first portion (e.g., the first portion 210a of FIG. 7), and/or the third housing area (e.g., the third housing area A3 of FIG. 7) when the wearable electronic device 200 is inserted and/or seated at the seating portion 412 such that the one surface S1 of the wearable electronic device 200 oriented a second direction (-Z direction) opposite to the first direction (+Z direction) (e.g., the state of FIGS. 22 and 23 in which the wearable electronic device 200 is fitted onto the seating portion 412 in an inverted orientation).

According to an embodiment, the charging device 400 may include a third wireless charging coil 420 (e.g., the coil 407 of FIG. 3). The third wireless charging coil 420 may be disposed in the second housing 410. The third wireless charging coil 420 may be disposed in the fifth portion 410a. The third wireless charging coil 420 may be disposed at a position facing the first wireless charging coil 250 of the wearable electronic device 200 when the wearable electronic device 200 is inserted and/or seated at the seating portion 412 in a normal orientation (e.g., the orientation of FIGS. 20 and 21).

According to an embodiment, the third wireless charging coil 420 may include a near-field communication (NFC) charging coil. In an embodiment, the third wireless charging coil 420 may further include a magnetic inductive charging coil, a magnetic resonant charging coil, and/or a coil used for a radio frequency charging scheme. According to an embodiment, the third wireless charging coil 420 may be referred to as a “TX coil” and/or a “TX antenna.”

According to an embodiment, the third wireless charging coil 420 may be configured to wirelessly transmit power to the wearable electronic device 200 (e.g., the first wireless charging coil 250) via at least a portion of the second housing 410. For example, when the wearable electronic device 200 is seated on the charging device 400 (e.g., the seating portion 412) in a normal orientation (e.g., the orientation of FIGS. 20 and 21), the third wireless charging coil 420 may face the first wireless charging coil 250 and may transmit power to the first wireless charging coil 250.

According to an embodiment, the charging device 400 may include a fourth wireless charging coil 430 (e.g., the coil 407 of FIG. 3). The fourth wireless charging coil 430 may be disposed in the second housing 410. The fourth wireless charging coil 430 may be disposed in the sixth portion 410b. The fourth wireless charging coil 430 may be disposed at a position facing the first wireless charging coil 250 of the wearable electronic device 200 when the wearable electronic device 200 is fitted onto the seating portion 412 in an inverted orientation (e.g., the orientation of FIGS. 22 and 23).

According to an embodiment, when the wearable electronic device 200 is seated on the charging device 400 (e.g., seating portion 412), the fourth wireless charging coil 430 may be disposed at a position that is line-symmetrical to the third wireless charging coil 420 with respect to the horizontal axis HA passing through the center of the ring shape of the first housing 210 of the wearable electronic device 200 (e.g., a point through which a ring axis RA passes) and the protrusion 213. Through this, both of the case where the wearable electronic device 200 is seated on the charging device 400 (e.g., the seating portion 412) in a normal orientation (e.g., the orientation of FIGS. 20 and 21) or the case where the wearable device 200 is seated on the charging device 400 (e.g., the seating portion 412) in an inverted orientation (e.g., the orientation of FIGS. 22 and 23), the first wireless charging coil 250 may face the third wireless charging coil 420 or the fourth wireless charging coil 430, and thus charging convenience may be improved.

According to an embodiment, the fourth wireless charging coil 430 may include a near-field communication (NFC) charging coil. In an embodiment, the fourth wireless charging coil 430 may include a magnetic inductive charging coil, a magnetic resonant charging coil, and/or a coil used for radio frequency charging scheme. According to an embodiment, the fourth wireless charging coil 430 may be referred to as a “TX coil” and/or a “TX antenna.”

According to an embodiment, the fourth wireless charging coil 430 may be configured to wirelessly transmit power to the wearable electronic device 200 (e.g., the first wireless charging coil 250) via at least a portion of the second housing 410. For example, when the wearable electronic device 200 is seated on the charging device 400 (e.g., the seating portion 412) in an inverted orientation, the fourth wireless charging coil 430 may face the first wireless charging coil 250 and may transmit power to the first wireless charging coil 250.

According to an embodiment, when the wearable electronic device (e.g., the wearable electronic device 300 of FIG. 19) includes the first wireless charging coil 350 and the second wireless charging coil 390, the third wireless charging coil 420 and the fourth wireless charging coil 430 may be configured to simultaneously transmit power to wireless charging coils (e.g., the first wireless charging coil 350 and the second wireless charging coil 390 of FIG. 19) of the wearable electronic device 200. For example, when the wearable electronic device (e.g., the wearable electronic device 300 of FIG. 19) includes the first wireless charging coil (e.g., the first wireless charging coil 350 of FIG. 19) and the second wireless charging coil (e.g., the second wireless charging coil 390 of FIG. 19), and when the wearable electronic device is mounted on the charging device 400 (e.g., the seating portion 412) in a normal orientation, the first wireless charging coil (e.g., the first wireless charging coil 350 of FIG. 19) and the second wireless charging coil (e.g., the second wireless charging coil 390 of FIG. 19) may respectively face the third wireless charging coil 420 and the fourth wireless charging coil 430. In this case, the third wireless charging coil 420 may transmit power to the first wireless charging coil (e.g., the first wireless charging coil 350 of FIG. 19), and the fourth wireless charging coil 430 may transmit power to the second wireless charging coil (e.g., the second wireless charging coil 390 of FIG. 19). For example, when the wearable electronic device (e.g., the wearable electronic device 300 of FIG. 19) includes the first wireless charging coil (e.g., the first wireless charging coil 350 of FIG. 19) and the second wireless charging coil (e.g., the second wireless charging coil 390 of FIG. 19), and when the wearable electronic device is mounted on the charging device 400 (e.g., the seating portion 412) in an inverted orientation, the first wireless charging coil (e.g., the first wireless charging coil 350 of FIG. 19) and the second wireless charging coil (e.g., the second wireless charging coil 390 of FIG. 19) may respectively face the fourth wireless charging coil 430 and the third wireless charging coil 420. In this case, the third wireless charging coil 420 may transmit power to the first wireless charging coil (e.g., the first wireless charging coil 350 of FIG. 19), and the fourth wireless charging coil 430 may transmit power to the second wireless charging coil (e.g., the second wireless charging coil 390 of FIG. 19).

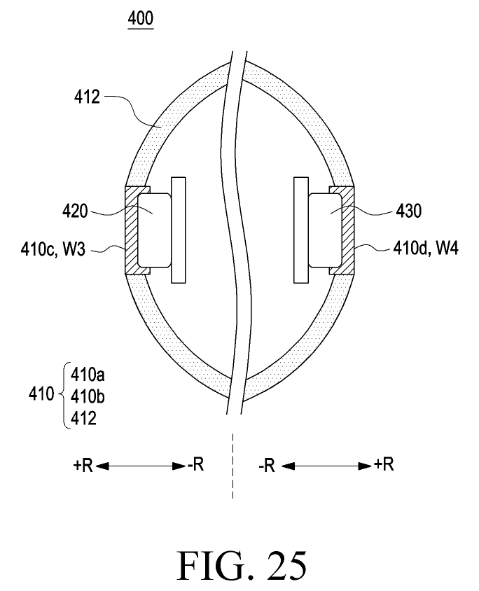

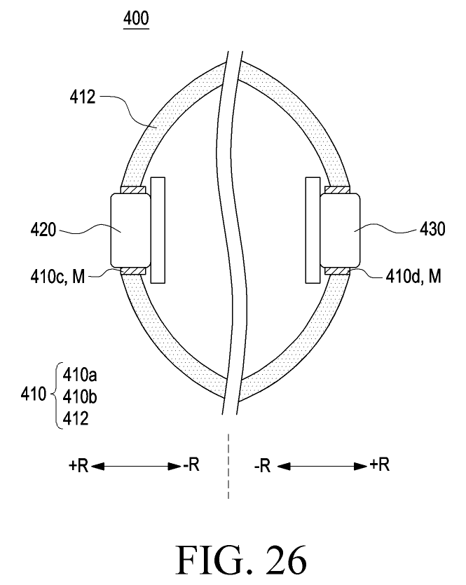

FIG. 24 is a diagram illustrating an enlarged view of a portion of a configuration of a charging device according to various embodiments. FIG. 25 is a diagram illustrating an enlarged view of a portion of a configuration of a charging device according to various embodiments. FIG. 26 is a diagram illustrating an enlarged view of a portion of a configuration of a charging device according to various embodiments.

FIGS. 24-26 illustrate enlarged views of portions in which the third wireless charging coil 420 and the fourth wireless charging coil 430 are disposed, and each of FIGS. 24-26 illustrates an example of a portion in which the third wireless charging coil 420 and the fourth wireless charging coil 430 are disposed.

Detailed configurations of the charging device 400 that are not described below may be the same as or similar to the detailed configurations of the charging device 400 described with reference to FIGS. 2 and 3 and 20-23.

According to an embodiment, the second housing 410 may include a third charging part 410c. The third charging part 410c may be a portion of the second housing 410 corresponding to the third wireless charging coil 420. For example, the third charging part 410c may be a portion facing the third wireless charging coil 420.

According to an embodiment, a surface (e.g., an outer circumferential surface) of the third charging part 410c that is exposed to the outside may be substantially planar. For example, the surface (e.g., the outer circumferential surface) of the third charging part 410c that faces the outer radial direction (+R direction) may be substantially planar. According to an embodiment, a surface (e.g., an inner circumferential surface) of the third charging part 410c that faces the third wireless charging coil 420 may be substantially planar. For example, the surface (e.g., the inner circumferential surface) of the third charging part 410c that faces the inner radial direction (-R direction) may be substantially planar. According to an embodiment, a first charging part 212a and/or a second charging part (e.g., the second charging part 312b of FIG. 19) of a wearable electronic device (e.g., the wearable electronic device 200 of FIGS. 11-13), which is configured to face the third charging part 410c, may also be substantially planar to correspond to the shape of the third charging part 410c. Through this, when the third wireless charging coil 420 faces the first wireless charging coil 250 (e.g., in the state of FIG. 21), the third wireless charging coil 420 may be disposed at a position closer to the first wireless charging coil 250.

According to an embodiment, a surface (e.g., an outer circumferential surface) of the fourth charging part 410d that is exposed to the outside may be substantially planar. For example, the surface (e.g., the outer circumferential surface) of the fourth charging part 410d that is oriented in the outer radial direction (+R direction) may be substantially flat. According to an embodiment, a surface (e.g., an inner circumferential surface) of the fourth charging part 410d that faces the fourth wireless charging coil 430 may be substantially planar. For example, the surface (e.g., the inner circumferential surface) of the fourth charging part 410d that is oriented in the inner radial direction (-R direction) may be substantially planar. According to an embodiment, a first charging part 212a and/or a second charging part (e.g., the second charging part 312b of FIG. 19) of a wearable electronic device (e.g., the wearable electronic device 200 of FIGS. 11 to 13), which is configured to face the third charging part 410c, may also be substantially planar to correspond to the shape of the third charging part 410c. Through this, when the fourth wireless charging coil 430 faces the first wireless charging coil 250 (e.g., in the state of FIG. 23), the fourth wireless charging coil 430 may be disposed at a position closer to the first wireless charging coil 250.

According to an embodiment (FIG. 24), a third charging part 410c and/or a fourth charging part 410d of the second housing 410 and a portion of the second housing 410 adjacent to the third charging part 410c and/or the fourth charging part 410d may include the same material. For example, the third charging part 410c and/or the fourth charging part 410d and the portion of the second housing 410 adjacent to the third charging part 410c and/or the fourth charging part 410d may be integrally formed. For example, the third charging part 410c and/or the fourth charging part 410d and the portion of the second housing 410 adjacent to the third charging part 410c and/or the fourth charging part 410d may be formed of a synthetic resin material (e.g., a plastic, resin, and/or epoxy material).

According to an embodiment (FIG. 24), the thickness (e.g., a length in the inner radial direction (-R direction) and/or the outer radial direction (+R direction)) of the third charging part 410c may be smaller than the thickness (e.g., a length in the inner radial direction (-R direction) and/or the outer radial direction (+R direction)) of the portion of the second housing 410 adjacent to the third charging part 410c. Through this, the third wireless charging coil 420 may be disposed at a position closer to the wearable electronic device (e.g., the wearable electronic device 200 of FIGS. 20-23).

According to an embodiment (FIG. 24), the thickness (e.g., a length in the inner radial direction (-R direction) and/or the outer radial direction (+R direction)) of the fourth charging part 410d may be smaller than the thickness (e.g., a length in the inner radial direction (-R direction) and/or the outer radial direction (+R direction)) of the portion of the second housing 410 adjacent to the fourth charging part 410d. Through this, the fourth wireless charging coil 430 may be disposed at a position closer to the wearable electronic device (e.g., the wearable electronic device 200 of FIGS. 20-23).

According to an embodiment (FIG. 25), the third charging part 410c of the second housing 410 and a portion of the second housing 410 adjacent to the third charging part 410c may include different materials. For example, the second housing 410 may include a third window part W3. The third window part W3 may be disposed in the third charging part 410c. The third window part W3 may include a material different from that of the portion of the second housing 410 adjacent to the third charging part 410c. For example, the portion of the second housing 410 adjacent to the third charging part 410c may include a metal material M, and the third window part W3 may include a synthetic resin material (e.g., a plastic, resin, and/or epoxy material). The third window part W3 may be referred to as a “window part.”

According to an embodiment (FIG. 25), the third wireless charging coil 420 may be disposed to be inserted, at least in part, into the third window part W3. For example, the third window part W3 may be disposed to surround at least a portion of the third wireless charging coil 420. For example, an end portion of the third wireless charging coil 420 oriented in the outer radial direction (+R direction) may be disposed closer to the outer radial direction (+R direction) side than to an end portion of the third window part W3 oriented in the inner radial direction. Such a structure may be formed by inserting the third wireless charging coil 420 into the third window part W3 in a liquid state during a molding process of the third window part W3, and then curing the third window part W3; however, the present disclosure is not limited thereto. For example, a groove into which a portion of the third wireless charging coil 420 may be inserted may be formed in the third window part W3, and the third wireless charging coil 420 may be inserted into the groove. By disposing the third wireless charging coil 420 to be inserted, at least in part, into the third window part W3, the third wireless charging coil 420 may be disposed at a position closer to a wearable electronic device (e.g., the wearable electronic device 200 of FIGS. 20-23).

According to an embodiment (FIG. 25), a fourth charging part 410d of the second housing 410 and a portion of the second housing 410 adjacent to the fourth charging part 410d may include different materials. For example, the second housing 410 may include a fourth window part W4. The fourth window part W4 may be disposed in the fourth charging part 410d. The fourth window part W4 may include a material different from that of the portion of the second housing 410 adjacent to the fourth charging part 410d. For example, the portion of the second housing 410 adjacent to the fourth charging part 410d may include a metal material M, and the fourth window part W4 may include a synthetic resin material (e.g., a plastic, resin, and/or epoxy material). The fourth window part W4 may be referred to as a “window part.”

According to an embodiment (FIG. 25), the fourth wireless charging coil 430 may be disposed to be inserted, at least in part, into the fourth window part W4. For example, the fourth window part W4 may be disposed to surround at least a portion of the fourth wireless charging coil 430. For example, an end portion of the fourth wireless charging coil 430 oriented in the outer radial direction (+R direction) may be disposed closer to the outer radial direction (+R direction) side than to an end portion of the fourth window part W4 oriented in the inner radial direction. Such a structure may be formed by inserting the fourth wireless charging coil 430 into the fourth window part W4 in a liquid state during a molding process of the fourth window part W4, and then curing the fourth window part W4; however, the present disclosure is not limited thereto. For example, a groove into which a portion of the fourth wireless charging coil 430 may be inserted may be formed in the fourth window part W4, and the fourth wireless charging coil 430 may be inserted into the groove. By disposing the fourth wireless charging coil 430 to be inserted, at least in part, into the fourth window part W4, the fourth wireless charging coil 430 may be disposed at a position closer to a wearable electronic device (e.g., the wearable electronic device 200 of FIGS. 20-23).

According to an embodiment (FIG. 26), a portion of the third wireless charging coil 420 may protrude to the outside of the second housing 410. For example, a portion of the third wireless charging coil 420 may protrude from the second housing 410 in the outer radial direction (+R direction) through the second housing 410. A gap formed between the third wireless charging coil 420 and the second housing 410 may be sealed by a synthetic resin material (e.g., a plastic, resin, and/or epoxy material).

According to an embodiment (FIG. 26), a portion of the fourth wireless charging coil 430 may protrude to the outside of the second housing 410. For example, a portion of the fourth wireless charging coil 430 may protrude from the second housing 410 in the outer radial direction (+R direction) through the second housing 410. A gap formed between the fourth wireless charging coil 430 and the second housing 410 may be sealed by a synthetic resin material (e.g., a plastic, resin, and/or epoxy material).

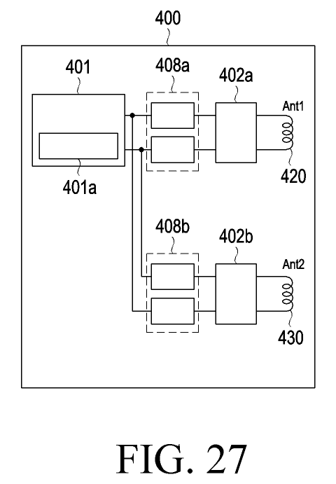

FIG. 27 is a circuit diagram illustrating a portion of a configuration of a charging device according to various embodiments.

FIG. 27 illustrates a portion of a charging circuit of a charging device 400.

Detailed configurations of the charging device 400 that are not described below may be the same as or similar to the detailed configurations of the charging device 400 described with reference to FIGS. 2 and 3 and FIGS. 20-26.

According to an embodiment, the charging device 400 may include a first matching circuit 402a (e.g., the matching circuit 402 of FIG. 3). One end of the first matching circuit 402a may be connected to a first switch 408a. The other end of the first matching circuit 402amay be connected to a third wireless charging coil 420.

According to an embodiment, the charging device 400 may include the first switch 408a. One end of the first switch 408a may be connected to a communication circuit 401 (e.g., the communication circuit 401 of FIG. 3). The other end of the first switch 408a may be connected to the first matching circuit 402a. The first switch 408a may be configured to allow power to be transmitted from the communication circuit 401 to the third wireless charging coil 420, or to block power transmitted from the communication circuit 401 to the third wireless charging coil 420.

According to an embodiment, the charging device 400 may include a second matching circuit 402b (e.g., the matching circuit 402 of FIG. 3). One end of the second matching circuit 402b may be connected to a second switch 408b. The other end of the second matching circuit 402b may be connected to a fourth wireless charging coil 430.

According to an embodiment, the charging device 400 may include the second switch 408b. One end of the second switch 408bmay be connected to the communication circuit 401. The other end of the second switch 408b may be connected to the second matching circuit 402b. The second switch 408b may be configured to allow power to be transmitted from the communication circuit 401 to the fourth wireless charging coil 430, or to block power transmitted from the communication circuit 401 to the fourth wireless charging coil 430.

According to an embodiment, when the wearable electronic device 200 is seated on the charging device 400 such that the first wireless charging coil 250 faces one of the third wireless charging coil 420 or the fourth wireless charging coil 430, one of the third wireless charging coil 420 or the fourth wireless charging coil 430 may be configured to transmit power, and the other of the third wireless charging coil 420 or the fourth wireless charging coil 430 may be configured not to transmit power. For example, when the first wireless charging coil (e.g., the first wireless charging coil 250 of FIGS. 20 and 21) of the wearable electronic device (e.g., the wearable electronic device 200 of FIGS. 20 and 21) faces the third wireless charging coil 420, the first switch 408a may allow power to be transmitted to the third wireless charging coil 420, and the second switch 408b may block power from being transmitted to the fourth wireless charging coil 430. For example, when the first wireless charging coil (e.g., the first wireless charging coil 250 of FIGS. 22 and 23) of the wearable electronic device (e.g., the wearable electronic device 200 of FIGS. 22 and 23) faces the fourth wireless charging coil 430, the first switch 408a may block power from being transmitted to the third wireless charging coil 420, and the second switch 408b may allow power to be transmitted to the fourth wireless charging coil 430. In this manner, depending on which wireless charging coil of the charging device 400 the first wireless charging coil (e.g., the first wireless charging coil 250 of FIGS. 20-23) faces, power may be selectively transmitted to the third wireless charging coil 420 or the fourth wireless charging coil 430, whereby power consumption may be reduced and heat generation may be reduced.

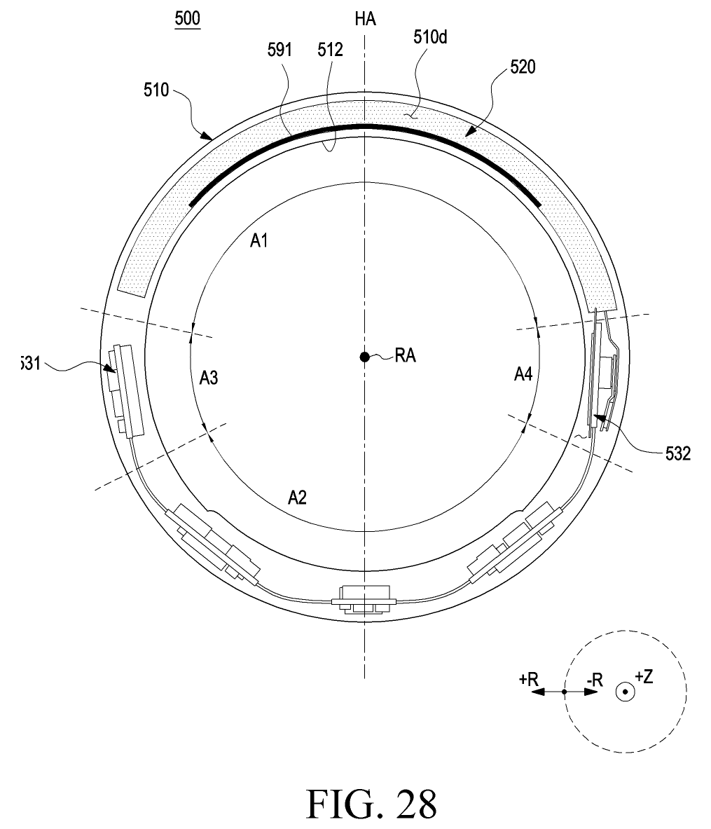

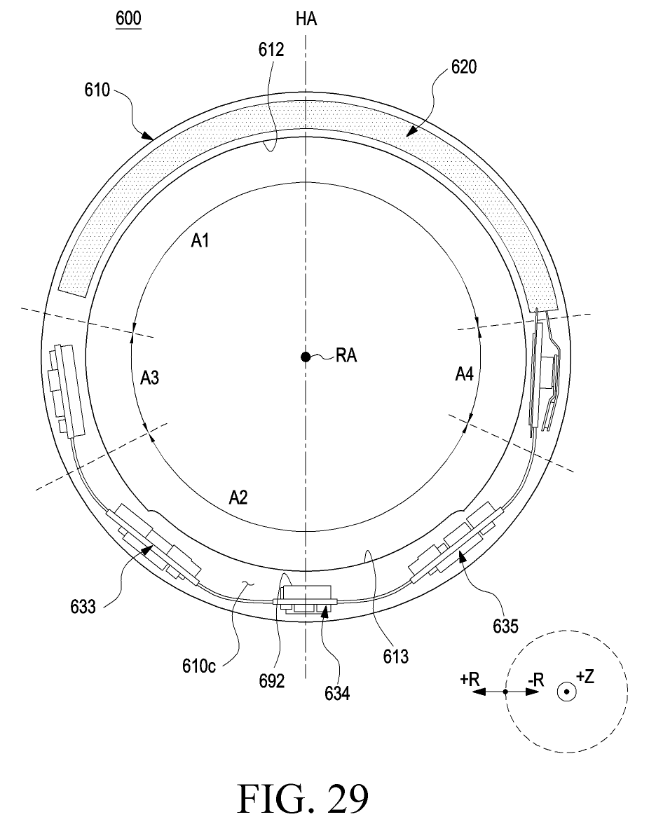

FIG. 28 is a cross-sectional view of a wearable electronic device according to various embodiments. FIG. 29 is a cross-sectional view of a wearable electronic device according to various embodiments.

FIGS. 28 and 29 each illustrate a first housing 510 cut such that an internal configuration of a wearable electronic device 500 is visible, and illustrate an example of an arrangement structure of wireless charging coils.

Detailed configurations of the wearable electronic device 500 that are not described below may be the same as or similar to the detailed configurations of the electronic device 101 described with reference to FIG. 1, the detailed configurations of the wearable electronic device 200 described with reference to FIGS. 2-18, and/or the detailed configurations of the wearable electronic device 300 described with reference to FIG. 19.

According to an embodiment, referring to FIG. 28, the wearable electronic device 500 may include a fifth wireless charging coil 591 (e.g., the coil 250 of FIG. 3). The fifth wireless charging coil 591 may be disposed in a first housing area A1 (e.g., the first housing area A1 of FIG. 7). For example, the fifth wireless charging coil 591 may be disposed in a fourth portion 510d (e.g., the fourth portion 210d of FIG. 7) of the first housing 510 (e.g., the first housing 210 of FIG. 7). For example, the fifth wireless charging coil 591 may be disposed in an area in which a battery 520 (e.g., the battery 220 of FIG. 7) is disposed. For example, the fifth wireless charging coil 591 may be disposed on a surface of the battery 520 that faces the ring axis RA (e.g., in the inner radial direction (-R direction)).

According to an embodiment, the fifth wireless charging coil 591 may be a near-field communication (NFC) charging coil. In an embodiment, the fifth wireless charging coil 591 may be a magnetic inductive charging coil, a magnetic resonant charging coil, and/or a coil used for a radio frequency charging scheme. According to an embodiment, the fifth wireless charging coil 591 may be referred to as an “RX coil” and/or an “RX antenna.”

According to an embodiment, the fifth wireless charging coil 591 may be electrically connected to a second circuit board 532 (e.g., the second circuit board 232 of FIG. 7). According to an embodiment, for example, the fifth wireless charging coil 591 may be electrically connected to the second circuit board 532 via a conductive member. In an embodiment, the fifth wireless charging coil 591 may be electrically connected to a first circuit board 531 (e.g., the first circuit board 231 of FIG. 7). For example, the fifth wireless charging coil 591 may be electrically connected to the first circuit board 531 via a conductive member.

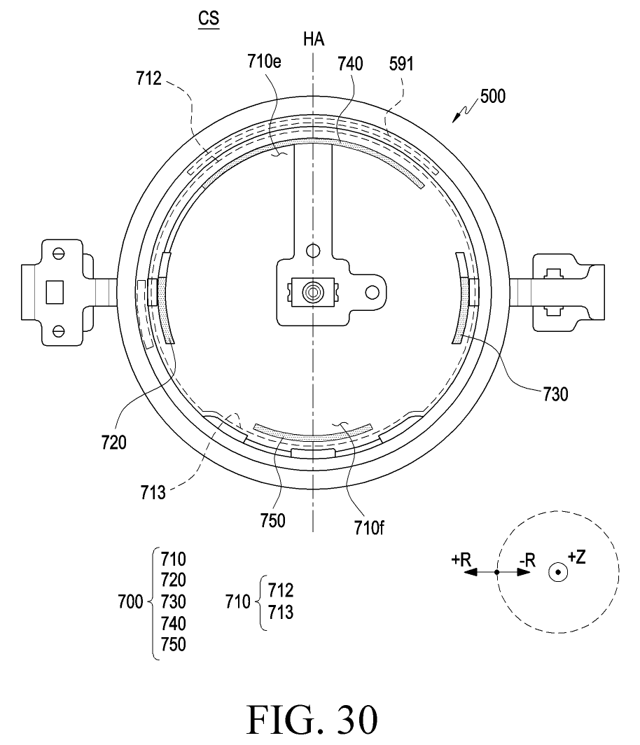

According to an embodiment, the fifth wireless charging coil 591 may be configured to wirelessly charge the battery 520 via at least a portion of an inner housing part 512 (e.g., the inner housing part 212 of FIG. 7) of a first housing 510 (e.g., the first housing 210 of FIG. 7) of the wearable electronic device 500. For example, when the wearable electronic device 500 is seated on a charging device (e.g., the charging device 700 of FIG. 30), the fifth wireless charging coil 591 may face a seventh wireless charging coil (e.g., the seventh wireless charging coil 740 of FIG. 30) of the charging device (e.g., the charging device 700 of FIG. 30) and may receive power.

According to an embodiment, referring to FIG. 29, a wearable electronic device 600 may include a sixth wireless charging coil 692 (e.g., the coil 250 of FIG. 3). The sixth wireless charging coil 692 may be disposed in a second housing area A2 (e.g., the second housing area A2 of FIG. 7). For example, the sixth wireless charging coil 692 may be disposed in an area of an internal area of a first housing 610 that is located on an opposite side of an area in which a battery 620 is disposed. For example, the sixth wireless charging coil 692 may be disposed in a third portion 610c (e.g., the third portion 210c of FIG. 7) of the first housing 510. For example, the sixth wireless charging coil 692 may be disposed in an area in which a third circuit board 633 (e.g., the third circuit board 233 of FIG. 7), a fourth circuit board 634 (e.g., the fourth circuit board 234 of FIG. 7), and/or a fifth circuit board 635 (e.g., the fifth circuit board 235 of FIG. 7) are disposed. For example, the sixth wireless charging coil 692 may be disposed on a surface of the fourth circuit board 634 oriented in the inner radial direction (-R direction).

According to an embodiment, the sixth wireless charging coil 692 may be a near-field communication (NFC) charging coil. In an embodiment, the sixth wireless charging coil 692 may be a magnetic inductive charging coil, a magnetic resonant charging coil, and/or a coil used for a radio frequency charging scheme. According to an embodiment, the sixth wireless charging coil 692 may be referred to as an “RX coil” and/or an “RX antenna.”

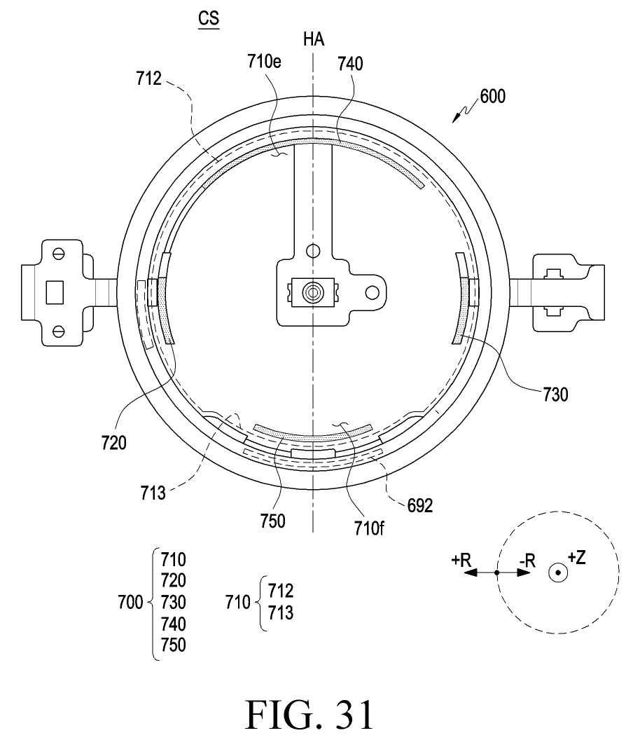

According to an embodiment, the sixth wireless charging coil 692 may be configured to wirelessly charge the battery 620 (e.g., the battery 220 of FIG. 7) via at least a portion of an inner housing part 612 (e.g., the inner housing part 212 of FIG. 7) of the first housing 610 (e.g., the first housing 210 of FIG. 7) and/or through a protrusion 613 (e.g., the protrusion 213 of FIG. 7) of the first housing 610. For example, when the wearable electronic device 600 is seated on a charging device (e.g., the charging device 700 of FIG. 31), the sixth wireless charging coil 692 may face an eighth wireless charging coil (e.g., the eighth wireless charging coil 750 of FIG. 31) of the charging device (e.g., the charging device 700 of FIG. 31) and may receive power.

In an embodiment, the fifth wireless charging coil 591 of FIG. 28 and the sixth wireless charging coil 692 of FIG. 29 may be selectively provided. In an embodiment, the fifth wireless charging coil 591 of FIG. 28 and the sixth wireless charging coil 692 of FIG. 29 may be simultaneously provided. In an embodiment, the fifth wireless charging coil 591 of FIG. 28 and/or the sixth wireless charging coil 692 of FIG. 29 may be alternatively provided with respect to a first wireless charging coil (e.g., the first wireless charging coil 250 of FIG. 7 and/or the first wireless charging coil 350 of FIG. 19) and/or a second wireless charging coil (e.g., the second wireless charging coil 390 of FIG. 19). In an embodiment, the fifth wireless charging coil 591 of FIG. 28 and/or the sixth wireless charging coil 692 of FIG. 29 may additionally be provided with respect to the first wireless charging coil and/or the second wireless charging coil.

FIG. 30 is a diagram illustrating a plan view of the charging system according to various embodiments. FIG. 31 is a diagram illustrating a plan view of the charging system according to various embodiments.

FIGS. 30 and 31 respectively illustrate states in which wearable electronic devices 500 and 600 are seated on a charging device 700, and illustrate a charging system CS as viewed in a first direction (+Z direction), in which an internal configuration of the charging system CS is illustrated to be visible through a second housing 710.

Detailed configurations of the wearable electronic device 500 of FIG. 30 and/or detailed configurations of the wearable electronic device 600 of FIG. 31 that are not described hereinafter may be the same as, or similar to, the detailed configurations of the electronic device 101 described with reference to FIG. 1, the detailed configurations of the wearable electronic device 200 described with reference to FIGS. 2-18, the detailed configurations of the wearable electronic device 300 described with reference to FIG. 19, and the detailed configurations of the wearable electronic device 500 described with reference to FIG. 28 and/or the wearable electronic device 600 described with reference to FIG. 29.

Detailed configurations of the charging device 700 that are not described hereinafter may be the same as, or similar to, the detailed configurations of the charging device 400 described with reference to FIGS. 2, 3, and 20-27.

According to an embodiment, the charging device 700 may include a seventh portion 710e. According to an embodiment, the seventh portion 710e may be a portion of an inner space of a second housing 710 (e.g., the second housing 410 of FIGS. 20-26). For example, the seventh portion 710e may be a portion of an inner space of a seating portion 712 (e.g., the seating portion 412 of FIGS. 20-26). The seventh portion 710e may be a portion that at least partially faces and/or is adjacent to a battery 520 (e.g., the battery 520 of FIGS. 28 and 29) and/or a fifth wireless charging coil 591 (e.g., the fifth wireless charging coil 591 of FIG. 28) of the wearable electronic device 500 (e.g., the wearable electronic device 500 of FIGS. 28 and 29) when the wearable electronic device 500 is inserted and/or seated at the seating portion 712. For example, the seventh portion 710e may be a portion corresponding to a fourth portion (e.g., the fourth portion 510d of FIG. 28) and/or a first housing area (e.g., the first housing area A1 of FIG. 28) of the wearable electronic device 500 when the wearable electronic device 500 is inserted and/or seated at the seating portion 712.

According to an embodiment, the charging device 700 may include an eighth portion 710f. The eighth portion 710f may be a portion of an inner space of the second housing 710. For example, the eighth portion 710f may be a portion of the inner space of the second housing 710. The eighth portion 710f may be a portion that at least partially faces a fourth circuit board (e.g., the fourth circuit board 634 of FIG. 29) and/or a sixth wireless charging coil 692 (e.g., the sixth wireless charging coil 692 of FIG. 29) of the wearable electronic device 500 when the wearable electronic device 500 is fitted onto the seating portion 712 and/or seated. For example, the eighth portion 710f may be a portion corresponding to a third portion (e.g., the third portion 610c of FIG. 29) and/or a second housing area (e.g., the second housing area A1 of FIG. 29) of the wearable electronic device 600 when the wearable electronic device 600 is inserted onto the seating portion 712 and/or seated. The eighth portion 710f may be a portion adjacent to a fitting groove 713 (e.g., the fitting groove 413 of FIGS. 20-23) within the inner space of the second housing 710.

According to an embodiment, the charging device 700 may include a seventh wireless charging coil 740 (e.g., the coil 407 of FIG. 3). The seventh wireless charging coil 740 may be disposed in the second housing 710. The seventh wireless charging coil 740 may be disposed in the seventh portion 710e. The seventh wireless charging coil 740 may be disposed at a position facing a fifth wireless charging coil 591 (e.g., the fifth wireless charging coil 591 of FIG. 28) of the wearable electronic device 500 when the wearable electronic device 500 is fitted onto the seating portion 712 and/or seated.

According to an embodiment, the seventh wireless charging coil 740 may include a near-field communication (NFC) charging coil. In an embodiment, the seventh wireless charging coil 740 may include a magnetic inductive charging coil, a magnetic resonant charging coil, and/or a coil used for radio frequency charging scheme. According to an embodiment, the seventh wireless charging coil 740 may be referred to as a “TX coil” and/or a “TX antenna.”

According to an embodiment, the seventh wireless charging coil 740 may be configured to wirelessly transmit power to the wearable electronic device 500 (e.g., the fifth wireless charging coil 591) via at least a portion of the second housing 710. For example, when the wearable electronic device 500 is fitted onto the seating portion 712, the seventh wireless charging coil 740 may face the fifth wireless charging coil 591 and may transmit power to the fifth wireless charging coil 591.

According to an embodiment, the charging device 700 may include an eighth wireless charging coil 750 (e.g., the coil 407 of FIG. 3). The eighth wireless charging coil 750 may be disposed in the second housing 710. The eighth wireless charging coil 750 may be disposed in the eighth portion 710f. The eighth wireless charging coil 750 may be disposed at a position facing a sixth wireless charging coil 692 (e.g., the sixth wireless charging coil 692 of FIG. 29) of the wearable electronic device 600 when the wearable electronic device 600 is fitted onto the seating portion 712 and/or seated.

According to an embodiment, the eighth wireless charging coil 750 may include a near-field communication (NFC) charging coil. In an embodiment, the eighth wireless charging coil 750 may include a magnetic inductive charging coil, a magnetic resonant charging coil, and/or a coil used for radio frequency charging scheme. According to an embodiment, the eighth wireless charging coil 750 may be referred to as a “TX coil” and/or a “TX antenna.”

According to an embodiment, the eighth wireless charging coil 750 may be configured to wirelessly transmit power to the wearable electronic device 600 (e.g., the sixth wireless charging coil 692) via at least a portion of the second housing 710. For example, when the wearable electronic device 600 is fitted onto the seating portion 712, the eighth wireless charging coil 750 may face the sixth wireless charging coil 692 and may transmit power to the sixth wireless charging coil 692.

According to an embodiment, the seventh wireless charging coil 740 and/or the eighth wireless charging coil 750 may be additionally provided with respect to the third wireless charging coil 720 (e.g., the third wireless charging coil 720 of FIGS. 21 and 23) and the fourth wireless charging coil 730 (e.g., the fourth wireless charging coil 730 of FIGS. 21 and 23). Through this, since various types of wearable electronic devices, depending on the arrangement of wireless charging coils, may be wirelessly charged by the charging device 700, versatility of the charging device 700 may be improved. For example, the wearable electronic device 200 illustrated in FIG. 7 may be charged by the first wireless charging coil (e.g., the first wireless charging coil 250 of FIG. 7) facing the third wireless charging coil 720 or the fourth wireless charging coil 730 of the charging device 700. For example, the wearable electronic device 300 illustrated in FIG. 19 may be charged by the first wireless charging coil (e.g., the first wireless charging coil 350 of FIG. 19) and the second wireless charging coil (e.g., the second wireless charging coil 390 of FIG. 19) respectively facing the third wireless charging coil 720 and the fourth wireless charging coil 730 of the charging device 700, or respectively facing the fourth wireless charging coil 730 and the third wireless charging coil 720 of the charging device 700. For example, the wearable electronic device 500 illustrated in FIG. 28 may be charged by the fifth wireless charging coil 591 facing the seventh wireless charging coil 740 of the charging device 700. For example, the wearable electronic device 600 illustrated in FIG. 29 may be charged by the sixth wireless charging coil 692 facing the eighth wireless charging coil 750 of the charging device 700.

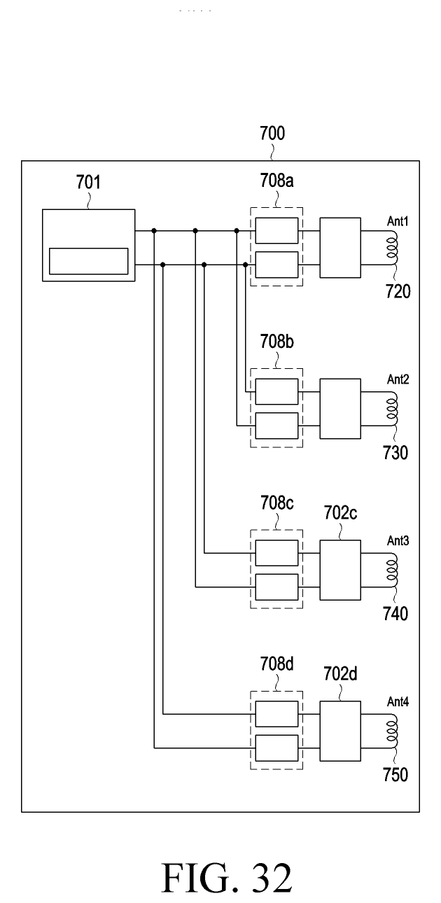

FIG. 32 is a circuit diagram illustrating a portion of a configuration of a charging device according to various embodiments.

FIG. 32 illustrates a portion of a charging circuit of a charging device 700.

According to an embodiment, detailed configurations of the charging device 700 that are not described below may be the same as or similar to the detailed configurations of the charging device 400 described in connection with FIGS. 2 and 3 and 20-27 and/or the detailed configurations of the charging device 700 described in connection with FIG. 30.

According to an embodiment, the charging device 700 may include a third matching circuit 702c (e.g., the matching circuit 402 of FIG. 3). One end of the third matching circuit 702c may be connected to a third switch 708c. The other end of the third matching circuit 702c may be connected to the seventh wireless charging coil 740.

According to an embodiment, the charging device 700 may include the third switch 708c. One end of the third switch 708c may be connected to a communication circuit 701 (e.g., the communication circuit 401 of FIG. 3). The other end of the third switch 708c may be connected to the third matching circuit 702c. The third switch 708c may be configured to allow power to be transmitted from the communication circuit 701 to the seventh wireless charging coil 740, or to block power transmitted from the communication circuit 701 to the seventh wireless charging coil 740.

According to an embodiment, the charging device 700 may include a fourth matching circuit 702d (e.g., the matching circuit 402 of FIG. 3). One end of the fourth matching circuit 702d may be connected to a fourth switch 708d. The other end of the fourth matching circuit 702d may be connected to the eighth wireless charging coil 750.

According to an embodiment, the charging device 700 may include the fourth switch 708d. According to an embodiment, one end of the fourth switch 708d may be connected to the communication circuit 701 (e.g., the communication circuit 401 of FIG. 3). The other end of the fourth switch 708d may be connected to the fourth matching circuit 702d. The fourth switch 708d may be configured to allow power to be transmitted from the communication circuit 701 to the eighth wireless charging coil 750, or to block power transmitted from the communication circuit 701 to the eighth wireless charging coil 750.

According to an embodiment, the first switch 708a (e.g., the first switch 708a of FIG. 27), the second switch 708b (e.g., the second switch 708b of FIG. 27), the third switch 708c, and the fourth switch 708d may each allow power to be transmitted to a wireless charging coil, among the wireless charging coils respectively connected thereto (e.g., the third wireless charging coil 720, the fourth wireless charging coil 730, the seventh wireless charging coil 740, and the eighth wireless charging coil 750), that faces a wireless charging coil of a wearable electronic device, and may block power from being transmitted to a wireless charging coil that does not face the wireless charging coil of the wearable electronic device. Through this, power consumption and heat generation may be reduced.

A ring-type wearable electronic device may be placed on a charging device (e.g., a cradle) and may be wirelessly charged. A wearable electronic device may include an RX coil configured to receive power from a TX coil included in a charging device. In the related art, a structure has been introduced in which an RX coil is disposed in a portion of an internal space of a housing of a wearable electronic device in which a battery is disposed. For example, in a conventional wearable electronic device, an RX coil was disposed on a surface of a battery that faces a center of a ring shape of the battery.

However, the battery occupies the largest volume among the internal components of the wearable electronic device, and in the conventional wearable electronic device, since the RX coil is disposed in an area in which the battery is disposed, there has been a limitation in reducing the thickness of a ring-type wearable electronic device. In addition, when the thickness of the battery is reduced in order to reduce the thickness of the ring-type wearable electronic device, the capacity of the battery may be reduced.

An issue to be addressed to by the disclosure is to provide a structure capable of reducing a thickness of a ring-type wearable electronic device while maintaining a capacity of a battery.

An issue to be addressed by the disclosure is to improve charging convenience of a wearable electronic device through a structure in which the wearable electronic device may be charged regardless of whether a ring-type wearable electronic device is mounted on a charging device in a normal orientation or in an inverted orientation (an orientation obtained by flipping from the normal orientation).

The issues to be addressed by the disclosure are not limited to the above-mentioned issues, and various other issues may be derived within a scope that does not depart from the spirit and scope of the disclosure.

Through a wearable electronic device and a charging system according to an embodiment, while maintaining a capacity of a battery, a thickness of a ring-type wearable electronic device may be reduced, so that downsizing of the wearable electronic device may be possible.

Through the wearable electronic device and the charging system according to an embodiment, charging convenience of the wearable electronic device may be improved.

The effects that are capable of being obtained by the disclosure are not limited to those described above, and other effects not described above may be clearly understood by a person ordinarily skilled in the art to which the disclosure belongs based on the description.

According to an example embodiment, a ring-type wearable electronic device 200 or 300 may include a ring-shaped housing 210 or 310 including an outer housing part 211 and an inner housing part 212 or 312.

According to an example embodiment, the ring-type wearable electronic device 200 or 300 may include a curved battery 220 or 320 disposed inside the housing.

According to an example embodiment, the ring-type wearable electronic device 200 or 300 may include a first wireless charging coil 250 or 350 configured to wirelessly charge the curved battery via at least a portion of the inner housing part and disposed at a first portion 210a or 310a adjacent to a first end portion 220a of the curved battery.

According to an example embodiment, the ring-type wearable electronic device 200 or 300 may include a communication antenna 261 configured to communicate with an external electronic device via the inner housing part and disposed at a second portion 210b or 310b adjacent to a second end portion 220b or 320b of the curved battery, located at a side opposite to the first end portion.

In an example embodiment, the ring-type wearable electronic device 200 or 300 may include at least one sensor 270 configured to obtain data from a user and disposed at a third portion 210c located between the first portion 210a or 310a and the second portion 210b or 310b.

According to an example embodiment, the ring-type wearable electronic device 200 or 300 may further include a first circuit board 231 or 331 disposed at the first portion.

According to an example embodiment, the first wireless charging coil of the ring-type wearable electronic device 200 or 300 may be disposed on one surface of the first circuit board.

According to an example embodiment, a shielding member 251 may be disposed between the first wireless charging coil and the first circuit board of the ring-type wearable electronic device 200 or 300.

According to an example embodiment, at least one electronic component 253 may be disposed on the other surface of the first circuit board of the ring-type wearable electronic device 200 or 300.

According to an example embodiment, the ring-type wearable electronic device 200 or 300 may further include a substrate 252 disposed between the first circuit board and the shielding member.

According to an example embodiment, the first wireless charging coil of the ring-type wearable electronic device 200 or 300 may be electrically connected to the first circuit board via the substrate.

According to an example embodiment, a minimum value of a combined thickness of the first wireless charging coil, the first circuit board, the shielding member, the substrate, and the at least one electronic component of the ring-type wearable electronic device 200 or 300 may be smaller than the thickness of the curved battery.

According to an example embodiment, a maximum value of the combined thickness of the first wireless charging coil, the first circuit board, the shielding member, the substrate, and the at least one electronic component of the ring-type wearable electronic device 200 or 300 may be substantially equal to or smaller than the thickness of the curved battery.

According to an example embodiment, the ring-type wearable electronic device 200 or 300 may further include an attaching member 254 disposed between the first circuit board and the shielding member and configured to attach the shielding member to the first circuit board.

According to an example embodiment, the communication antenna of the ring-type wearable electronic device 200 or 300 may be disposed at a position substantially facing the first wireless charging coil.

According to an example embodiment, the housing of the ring-type wearable electronic device 200 or 300 may include a protrusion 313 protruding toward a center of the ring shape from the inner housing part.

According to an example embodiment, the first portion 310a and the second portion 310b of the ring-type wearable electronic device 200 or 300 may be respectively disposed at positions that are substantially line-symmetrical with respect to a horizontal axis HA passing through the center of the ring shape and the protrusion.

According to an example embodiment, the ring-type wearable electronic device 300 may further include a second wireless charging coil 390 disposed at the second portion 310b.

According to an example embodiment, the ring-type wearable electronic device 200 or 300 may further include a second circuit board 232 or 332 disposed at the second portion.

According to an example embodiment, the ring-type wearable electronic device 200 or 300 may further include an additional circuit board 233, 234, or 235 disposed between the first circuit board and the second circuit board, and the at least one sensor may be disposed at the additional circuit board.

According to an example embodiment, the first circuit board of the ring-type wearable electronic device 200 or 300 may be electrically connected to the curved battery via the additional circuit board and the second circuit board.

According to an example embodiment, the first circuit board of the ring-type wearable electronic device 200 or 300 may not be electrically connected to the first end portion of the curved battery.

According to an example embodiment, at least a portion of an outer region of the first wireless charging coil of the ring-type wearable electronic device 200 or 300 may have a lamination thickness that is greater than a lamination thickness of a central region of the first wireless charging coil.

According to an example embodiment, the first wireless charging coil of the ring-type wearable electronic device 200 or 300 may include a first coil area CA1 close to the first end portion of the curved battery, a second coil area CA2 far from the second end portion of the curved battery, and a third coil area CA3 between the first coil area and the second coil area.

According to an example embodiment, in at least one of the first coil area or the second coil area of the ring-type wearable electronic device 200 or 300, the number of laminated layers of the first wireless charging coil may be greater than the number of laminated layers of the first wireless charging coil in the third coil area CA3.

According to an example embodiment, the inner housing part of the ring-type wearable electronic device 200 or 300 may include a first charging part 212a that faces the first wireless charging coil.

According to an example embodiment, a surface of the first charging part of the ring-type wearable electronic device 200 or 300 that is exposed to the outside may be substantially planar.

According to an example embodiment, the housing of the ring-type wearable electronic device 200 or 300 may include a first window part W1 disposed at the first charging part.

According to an example embodiment, at least a portion of the first wireless charging coil of the ring-type wearable electronic device 200 or 300 may be disposed to be inserted into the first window part W1.

According to an example embodiment, the thickness of the first charging part of the ring-type wearable electronic device 200 or 300 may be smaller than the thickness of a portion of the inner housing part adjacent to the first charging part.

According to an example embodiment, a charging system CS may be for charging the ring-type wearable electronic device 200 or 300.

According to an example embodiment, the charging system CS may include a wearable electronic device 200 or 300.

According to an example embodiment, the charging system CS may include a charging device 400 that is configured such that the wearable electronic device is seated thereon.

According to an example embodiment, the wearable electronic device of the charging system CS may include a first housing 210 or 310 including an outer housing part 211 and an inner housing part 212 or 312 that is at least partially transparent.

According to an example embodiment, the wearable electronic device of the charging system CS may include a curved battery 220 or 320 disposed inside the first housing.

According to an example embodiment, the wearable electronic device of the charging system CS may include a first wireless charging coil 250 or 350 configured to receive power wirelessly from the charging device via at least a portion of the inner housing part. The first wireless charging coil may be disposed inside the first housing at a first portion 210a or 310a adjacent to a first end portion 220a of the curved battery and may be electrically connected to the curved battery.

According to an example embodiment, the wearable electronic device of the charging system CS may include a communication antenna 261 configured to communicate with an external electronic device via at least a portion of the inner housing part. The communication antenna 261 may be disposed at a second portion adjacent to a second end portion 220b or 320b of the curved battery, located at a side opposite to the first end portion.

According to an example embodiment, the wearable electronic device of the charging system CS may include at least one sensor 270 configured to obtain data from a user and disposed at a third portion 210c located between the first portion and the second portion.

According to an example embodiment, the charging device 400 of the charging system CS may include a second housing 410 including a cylindrical seating portion 412.

According to an example embodiment, the charging device 400 of the charging system CS may include a third wireless charging coil 420 disposed inside the second housing 410. The third wireless charging coil 420 may be disposed at a fifth portion 410a corresponding to the first wireless charging coil when the wearable electronic device is seated at the seating portion such that one surface of the wearable electronic device is oriented in a first direction.

According to an example embodiment, the charging device 400 of the charging system CS may include a fourth wireless charging coil 430 disposed inside the second housing 410. The fourth wireless charging coil 430 may be disposed at a sixth portion 410b corresponding to the first wireless charging coil when the wearable electronic device is seated at the seating portion such that the one surface of the wearable electronic device is oriented in a second direction opposite to the first direction.

According to an example embodiment, the first housing of the charging system CS may include a protrusion 213 or 313 that protrudes from the inner housing part toward a center of the ring shape.

According to an example embodiment, the third wireless charging coil and the fourth wireless charging coil of the charging system CS may be disposed at positions that are substantially line-symmetric with respect to a horizontal axis HA passing through the center of the ring shape of the first housing and the protrusion when the wearable electronic device is seated on the charging device.

According to an example embodiment, the second housing of the charging system CS may include a third charging part 410c that faces the third wireless charging coil and a fourth charging part 410d that faces the fourth wireless charging coil.

According to an example embodiment, an outwardly exposed surface of at least one of the third charging part or the fourth charging part of the charging system CS may be substantially planar.

According to an example embodiment, the second housing of the charging system CS may include a third window part W3 disposed at the third charging part and a fourth window part W4 disposed at the fourth charging part.

According to an example embodiment, at least a portion of the third wireless charging coil of the charging system CS may be disposed to be inserted into the third window part.

According to an example embodiment, at least a portion of the fourth wireless charging coil of the charging system CS may be disposed to be inserted into the fourth window part.

According to an example embodiment, the thickness of the third charging part of the charging system CS may be smaller than the thickness of a portion of the second housing adjacent to the third charging part.

According to an example embodiment, the thickness of the fourth charging part of the charging system CS may be smaller than the thickness of a portion of the second housing adjacent to the fourth charging part.

According to an example embodiment, the charging device 700 of the charging system CS may further include a seventh wireless charging coil 740 disposed inside the second housing 710. The seventh wireless charging coil 740 may be disposed at a seventh portion 710e adjacent to the battery 520 when the wearable electronic device 500 is fitted onto the seating portion 712.

According to an example embodiment, the charging device 700 of the charging system CS may further include an eighth wireless charging coil 750 disposed inside the second housing 710. The eighth wireless charging coil 750 may be disposed at an eighth portion 710f, which is located at a side opposite to a portion facing the battery 520 within a region between the third wireless charging coil 720 and the fourth wireless charging coil 730 when the wearable electronic device 600 is fitted onto the seating portion 712.

In the foregoing detailed description of the disclosure, various example embodiments have been described. However, it will be evident to one skilled in the art that various modifications can be made without departing from the scope of the disclosure.

Although the disclosure has been described with reference to various example embodiments, it is to be understood that the various embodiments are intended to be examples and are not limiting the disclosure. It will be apparent to those skilled in the art that various changes in form and detail may be made without departing from the overall scope of the disclosure, including the appended claims and their equivalents. It will also be understood that any of the embodiment(s) described herein may be used in conjunction with any other embodiment(s) described herein.

What is claimed is:

1. A ring-type wearable electronic device, comprising:
a housing having a ring shape, and comprising an outer housing and an inner housing;
a curved battery disposed inside the housing;
a first wireless charging coil configured to wirelessly charge the curved battery via at least a portion of the inner housing, wherein the first wireless charging coil is disposed at a first portion adjacent to a first end portion of the curved battery;
a communication antenna configured to communicate with an external electronic device, wherein the communication antenna is disposed at a second portion adjacent to a second end portion, located at a side opposite to the first end portion, of the curved battery; and
at least one sensor configured to obtain data from a user, wherein the at least one sensor is disposed at a third portion between the first portion and the second portion.

2. The wearable electronic device of claim 1, further comprising:
a first circuit board disposed at the first portion,
wherein the first wireless charging coil is disposed on one surface of the first circuit board,
wherein a shielding member comprising a shield is disposed between the first wireless charging coil and the first circuit board, and
wherein at least one electronic component comprising circuitry is disposed on another surface of the first circuit board.

3. The wearable electronic device of claim 2, further comprising:
a substrate disposed between the first circuit board and the shielding member,
wherein the first wireless charging coil is electrically connected to the first circuit board via the substrate.

4. The wearable electronic device of claim 3, wherein a minimum value of a combined thickness of the first wireless charging coil, the first circuit board, the shielding member, the substrate and the at least one electronic component is less than a thickness of the curved battery.

5. The wearable electronic device of claim 4, wherein a maximum value of a combined thickness of the first wireless charging coil, the first circuit board, the shielding member, the substrate and the at least one electronic component is substantially equal to or less than a thickness of the curved battery.

6. The wearable electronic device of claim 2, further comprising:
an attaching member comprising an adhesive disposed between the first circuit board and the shielding member, and configured to attach the shielding member to the first circuit board.

7. The wearable electronic device of claim 1, wherein the communication antenna is disposed at a position substantially facing the first wireless charging coil.

8. The wearable electronic device of claim 1, wherein the housing comprises a protrusion protruding toward a center of the ring shape from the inner housing,
wherein the first portion and the second portion are respectively disposed at positions that are substantially line-symmetrical with respect to a horizontal axis passing through the center of the ring shape and the protrusion, and
wherein the wearable electronic device further comprises a second wireless charging coil disposed at the second portion.

9. The wearable electronic device of claim 1, further comprising:
a second circuit board disposed at the second portion; and
an additional circuit board disposed between the first circuit board and the second circuit board, wherein the at least one sensor is disposed at the additional circuit board,
wherein the first circuit board is electrically connected to the curved battery via the additional circuit board and the second circuit board.

10. The wearable electronic device of claim 1, wherein the first circuit board is not electrically connected to the first end portion of the curved battery.

11. The wearable electronic device of claim 1, wherein a lamination thickness of the first wireless charging coil in at least a portion of an outer region of the first wireless charging coil is greater than a lamination thickness of the first wireless charging coil in a central region of the first wireless charging coil.

12. The wearable electronic device of claim 11, wherein the first wireless charging coil comprises a first coil area within a specified proximity to the first end portion of the curved battery, a second coil area within a specified proximity of the second end portion of the curved battery, and a third coil area between the first coil area and the second coil area, and
wherein a number of laminated layers of the first wireless charging coil in at least one of the first coil area or the second coil area is greater than a number of laminated layers of the first wireless charging coil in the third coil area.

13. The wearable electronic device of claim 1, wherein the inner housing comprises a first charging part facing the first wireless charging coil, and
wherein a surface of the first charging part exposed to an outside is substantially planar.

14. The wearable electronic device of claim 13, wherein the housing comprises a first window disposed at the first charging part, and
wherein at least a portion of the first wireless charging coil is disposed to be inserted into the first window.

15. The wearable electronic device claim 13, wherein a thickness of the first charging part is less than a thickness of a portion of the inner housing adjacent to the first charging part.

16. A charging system configured to charge a ring-type wearable electronic device, the charging system (CS) comprising:
a wearable electronic device; and
a charging device configured such that the wearable electronic device is seatable thereon,
wherein the wearable electronic device comprises:
a first housing comprising an outer housing and an inner housing that is at least partially transparent,
a curved battery disposed inside the first housing,
a first wireless charging coil configured to receive power wirelessly from the charging device via at least a portion of the inner housing, wherein the first wireless charging coil is disposed inside the first housing at a first portion adjacent to a first end portion of the curved battery and is electrically connected to the curved battery,
a communication antenna configured to communicate with an external electronic device via at least a portion of the inner housing, wherein the communication antenna is disposed at a second portion adjacent to a second end portion of the curved battery, located at a side opposite to the first end portion, and
at least one sensor configured to obtain data from a user, wherein the at least one sensor is disposed at a third portion located between the first portion and the second portion, and
wherein the charging device comprises:
a second housing comprising a cylindrical seat,
a third wireless charging coil disposed inside the second housing, wherein, based on the wearable electronic device being seated at the seat such that one surface of the wearable electronic device is oriented in a first direction, the third wireless charging coil is disposed in a fifth portion corresponding to the first wireless charging coil, and
a fourth wireless charging coil disposed inside the second housing, wherein, based on the wearable electronic device being seated at the seat such that one surface thereof is oriented in a second direction opposite to the first direction, the fourth charging coil is disposed in a sixth portion corresponding to the first wireless charging coil.

17. The charging system of claim 16, wherein the first housing comprises a protrusion protruding toward a center of the ring shape from the inner housing, and
wherein the third wireless charging coil and the fourth wireless charging coil are disposed at positions that are substantially line-symmetric with respect to a horizontal axis passing through a center of the ring shape of the first housing and the protrusion based on the wearable electronic device being seated on the charging device.

18. The charging system (CS) of claim 16, wherein the second housing comprises a third charging part facing the third wireless charging coil and a fourth charging part facing the fourth wireless charging coil, and
wherein an outwardly exposed surface of at least one of the third charging part or the fourth charging part is substantially planar.

19. The charging system (CS) of claim 18, wherein the second housing comprises a third window disposed at the third charging part and a fourth window disposed at the fourth charging part,
wherein at least a portion of the third wireless charging coil is disposed to be inserted into the window part, and
wherein at least a portion of the fourth wireless charging coil is disposed to be inserted into the fourth window part.

20. The charging system (CS) of claim 18, wherein a thickness of the third charging part is less than a thickness of a portion of the second housing adjacent to the third charging part, and
wherein a thickness of the fourth charging part is less than a thickness of a portion of the second housing adjacent to the fourth charging part.
